(19) United States
(12) Patent Application Publication
(10) Pub. No.: US 2025/0329111 A1
(43) Pub. Date: Oct. 23, 2025

(54) GRAPHICS PROCESSING

(71) Applicant: Arm Limited, Cambridge (GB)

(72) Inventors: Philip Carlos Garcia, Austin, TX (US); Wing-Tsi Henry Wong, Lund (SE); Frank Klaeboe Langtind, Melhus (NO); Rafal Stepuch, Cambridge (GB)

(73) Assignee: Arm Limited, Cambridge (GB)

(21) Appl. No.: 18/637,572

(22) Filed: Apr. 17, 2024

(51) Int. Cl. G06T 17/20; G06T 1/20

(52) U.S. Cl. CPC G06T 17/20; G06T 1/20; G06T 2210/12

(57) ABSTRACT

A tile-based graphics processor that generates and traverses a hierarchy of bounding boxes is disclosed. A hierarchy of bounding boxes is generated by generating group bounding boxes that bound respective groups of primitives. Primitives are added to the groups by selecting a group to add a primitive to based on a comparison of a position of the primitive with a position of any group currently under construction.

### BACKGROUND

The technology described herein relates to computer graphics processing, and in particular to tile-based graphics processing.

Graphics processing is normally carried out by first splitting a scene (e.g. a 3-D model) to be displayed into a number of similar basic components or “primitives”, which primitives are then subjected to the desired graphics processing operations. The graphics “primitives” are usually in the form of simple polygons, such as triangles, quadrilaterals, points, lines, or groups thereof.

Each primitive is usually defined by and represented as a set of vertices (e.g. three vertices in the case of triangular primitive). Typically, the set of vertices to be used for a given graphics processing output (e.g. frame for display) will be stored as a set of vertex data defining the vertices, e.g. the relevant attributes for each of the vertices. These attributes will typically include position data and other, non-position data (varyings), e.g. defining colour, light, normal, texture coordinates, etc, for the vertex in question.

This geometry (vertex) data is processed by a graphics processor to generate the desired graphics processing output (render target), such as a frame for display. This typically comprises “assembling” primitives using the vertices, and then processing the so-assembled primitives.

The primitive processing may involve, for example, determining which sampling points of an array of sampling points associated with the output area to be processed are covered by a primitive, and then determining the appearance each sampling point should have (e.g. in terms of its colour, etc.) to represent the primitive at that sampling point. These processes are commonly referred to as rasterising and rendering, respectively.

The rasterising process typically determines the sample positions that should be used for a primitive (i.e. the (x, y) positions of the sample points to be used to represent the primitive in the output, e.g. frame to be displayed). The rendering process then derives (samples) the data, such as red, green and blue (RGB) colour values and an “Alpha” (transparency) value, necessary to represent the primitive at the sample points (i.e. “shades” each sample point). This can involve, for example, applying textures, blending sample point data values, etc.

One form of graphics processing uses so-called “tile-based” rendering. In tile-based rendering, the two-dimensional render output (i.e. the output of the rendering process, such as an output frame to be displayed) is rendered as a plurality of smaller area regions, usually referred to as “tiles”. The render output is typically divided (by area) into regularly-sized and shaped rendering tiles (they are usually e.g., squares or rectangles). The tiles are each rendered separately (e.g., one after another). The rendered tiles are then combined to provide the complete render output (e.g. frame for display).

Other terms that are commonly used for “tiling” and “tile-based” rendering include “chunking” (the rendering tiles are referred to as “chunks”) and “bucket” rendering. The terms “tile” and “tiling” will be used hereinafter for convenience, but it should be understood that these terms are intended to encompass all alternative and equivalent terms and techniques wherein the render output is rendered as a plurality of smaller area regions.

In a tile-based graphics processing pipeline, the primitives for the render output being generated may typically be sorted into primitive listing regions of the render output area, so as to allow the primitives that need to be processed for a given region (tile) of the render output to be identified. This sorting allows primitives that need to be processed for a given region (tile) of the render output to be identified so as to, e.g., avoid unnecessarily rendering primitives that are not actually present in a region (tile). The tiling process typically produces lists of (assembled) primitives to be rendered for different primitive listing regions of the render output, commonly referred to as “primitive lists” (or “tile lists”).

The primitive lists generated by the tiling process are typically written out to memory. Once the primitive lists have been prepared for all the render output regions and written out, each rendering tile is processed, by reading the primitive list(s) for the rendering tile, and rasterising and rendering the primitives listed in the primitive list(s) for the rendering tile.

Thus, tile-based graphics processing typically comprises an initial, geometry (“tiling”) processing pass in which primitives assembled from geometry data are sorted into primitive listing regions so as to generate primitive lists, and the generated primitive lists are written out to memory. In a subsequent “fragment processing” pass, the rendering tiles are each rendered separately, with the primitive lists being read from memory to determine which primitives to process (rasterise and render) for which rendering tiles.

An alternative tile-based graphics processing arrangement is described in United Kingdom Patent Application No. 2316170.6. In this process, the initial geometry processing pass involves building a hierarchy of bounding boxes representative of positions of primitives to be processed, and the subsequent fragment processing pass involves traversing the hierarchy of bounding boxes to identify which primitives to process (rasterise and render) for which rendering tiles.

The inventors believe there remains scope for improvements to tiling and tile-based graphics processors.

### BRIEF DESCRIPTION OF THE DRAWINGS

Embodiments of the technology described herein will now be described by way of example only and with reference to the accompanying drawings, in which:

FIG. 1 shows an exemplary graphics processing system;

FIG. 2 shows an exemplary tile-based graphics processor;

FIG. 3 shows a tile-based graphics processing pipeline according to embodiments;

FIG. 4 shows a memory layout in accordance with embodiments;

FIG. 5 shows a memory layout for a hierarchy of bounding boxes in accordance with embodiments;

FIG. 6 shows a tile-based graphics processing pipeline according to embodiments;

FIG. 7 shows a tile-based graphics processing pipeline according to embodiments;

FIG. 8 shows a hierarchical bounding box reader of a tile-based graphics processor in accordance with embodiments;

FIG. 9 shows an arrangement for a hierarchy of bounding boxes;

FIG. 10 shows an exemplary packet bounding box;

FIG. 11 shows a hierarchy of bounding boxes in accordance with embodiments of the technology described herein;

FIG. 12 shows an arrangement for a hierarchy of bounding boxes;

FIG. 13 shows a process for grouping primitives into primitive groups and generating primitive group bounding boxes, in accordance with embodiments of the technology described herein; and

FIG. 14A illustrates a primitive bounding box that fully overlaps a group bounding box; FIG. 14B illustrates a primitive bounding box that partially overlaps a group bounding box; and FIG. 14C illustrates a primitive bounding box that does not overlap a group bounding box;

FIG. 15 shows a hierarchy of bounding boxes in accordance with embodiments of the technology described herein; and

FIG. 16 shows a process for using a hierarchy of bounding boxes to determine which primitives to process to generate a rendering tile, in accordance with embodiments of the technology described herein.

### DETAILED DESCRIPTION

A first embodiment of the technology described herein comprises a method of operating a tile-based graphics processor that is operable to generate a render output by building a hierarchy of bounding boxes to be used to identify primitives to process to generate a (each) rendering tile of the render output; the method comprising building at least one level of a hierarchy of bounding boxes by:
constructing one or more groups of primitives by adding primitives to the one or more groups; and
generating, for each group, a group bounding box that bounds the primitives added to the respective group;
wherein a (each) primitive is added to a group by:
   comparing a position of the (respective) primitive with a position of any (each) group currently under construction;
   selecting a group to add the (respective) primitive to based on the comparison; and
   adding the (respective) primitive to the selected group.

A second embodiment of the technology described herein comprises a tile-based graphics processor that is operable to generate a render output by building a hierarchy of bounding boxes to be used to identify primitives to process to generate a (each) rendering tile of the render output; the processor comprising:
a bounding box hierarchy building circuit configured to build at least one level of a hierarchy of bounding boxes by:
   constructing one or more groups of primitives by adding primitives to the one or more groups; and
   generating, for each group, a group bounding box that bounds the primitives added to the respective group; and
a processing circuit configured to add a (each) primitive to a group by:
   comparing a position of the (respective) primitive with a position of any (each) group currently under construction;
   selecting a group to add the (respective) primitive to based on the comparison; and
   adding the (respective) primitive to the selected group.

The bounding box hierarchy building circuit and the processing circuit may comprise separate circuits, or may be at least partially formed of shared processing circuits. For example, the bounding box hierarchy building circuit may comprise the processing circuit.

The technology described herein relates to tile-based graphics processing. Thus, in embodiments, a (the) render output, e.g. frame (image) to be displayed, is generated by separately generating each rendering tile of plural rendering tiles that the render output is divided into, and combining the separately generated rendering tiles.

In the technology described herein, a (the) render output can be (and in embodiments is) generated by building a hierarchy of bounding boxes that are representative of positions of primitives that are to be processed (e.g. rasterised and rendered) to generate the render output, and traversing the bounding box hierarchy to determine which primitives to process (e.g. rasterise and render) when generating a (and in embodiments each) rendering tile of the render output. For example, and in embodiments, the graphics processor is arranged substantially as described in United Kingdom Patent Application No. 2316170.6, the entire contents of which is hereby incorporated herein by reference.

Thus, in embodiments, the graphics processor generates a (the) render output by performing (at least) a first processing pass and (thereafter) a second processing pass. In embodiments, the first processing pass generates and writes out (e.g. stores) bounding box hierarchy information (data) that is read in and used in the second processing pass to test bounding boxes to determine which primitives to process (e.g. rasterise and render) to generate a (each) particular rendering tile (and thus, in effect, which primitives do not need to be processed to generate a particular rendering tile).

As discussed in United Kingdom Patent Application No. 2316170.6, the use of a bounding box hierarchy in the manner of embodiments of the technology described herein can facilitate improved graphics processing performance.

In embodiments of the technology described herein, a hierarchy of bounding boxes comprises a respective set of one or more bounding boxes for each “level” of plural levels of the hierarchy, with at least one of the levels comprising a set of one or more group bounding boxes that each bound a respective group of primitives. Each such group of primitives is constructed by adding primitives to the group, in embodiments until a condition for completing construction of the group is reached.

In embodiments, there can be (and in embodiments are) plural groups under construction at any one time, such that for a (and in embodiments each) primitive that is to be added to a group, there can be (and in embodiments is) a choice to be made as to which group to add the primitive to.

In the technology described herein, this choice is made based on a comparison of a position of the (respective) primitive with a position of any group that is already under construction. For example, and in embodiments, if there is already a group under construction that covers the same or similar positions as the primitive, the primitive may be, and in embodiments is, added to that existing group. Otherwise, if there is not already a group under construction that covers the same or similar positions as the primitive, the primitive may be, and in embodiments is, added to new group.

The inventors have found that taking the position of existing groups already under construction into account when deciding on which group to add a primitive to can result in the generation of better localised (e.g. smaller) group bounding boxes, e.g. as compared to other arrangements that e.g. decide on which group to add a primitive to based on primitive processing order. As will be discussed in more detail below, the inventors have found that this can reduce an overall number of bounding box tests performed to determine which primitives are to be processed for which rendering tiles. This can accordingly save processing effort for tile-based graphics processing.

It will be appreciated therefore, that the technology described herein provides improved tile-based graphics processing.

The graphics processor should, and in embodiments does, generate an overall render output on a tile-by-tile basis. The render output (area) should thus be, and in embodiments is, divided into plural rendering tiles for rendering purposes.

The render output may comprise any suitable render output, such as frame for display, or render-to-texture output, etc., The render output will typically comprise an array of data elements (sampling points) (e.g. pixels), for each of which appropriate render output data (e.g. a set of colour value data) is generated by the graphics processor. The render output data may comprise colour data, for example, a set of red, green and blue, RGB values and a transparency (alpha, a) value. Where the graphics processor generates plural (e.g. a series of) render outputs, each render output may be generated in accordance with the technology described herein.

The tiles that the render output is divided into for rendering purposes can be any suitable and desired such tiles. The size and shape of the rendering tiles may normally be dictated by the tile configuration that the graphics processor is configured to use and handle.

The rendering tiles are in embodiments all the same size and shape (i.e. regularly-sized and shaped tiles are in embodiments used), although this is not essential. The tiles are in embodiments rectangular, and in embodiments square. The size and number of tiles can be selected as desired. In embodiments, each tile is 16×16, 32×32, or 64×64 data elements (sampling positions) in size (with the render output then being divided into however many such tiles as are required for the render output size and shape that is being used).

In embodiments, the tile-based graphics processor performs a first (geometry, e.g. tiling) processing pass and a second (e.g. fragment) processing pass in order to generate a (the) render output (e.g. frame for display). In embodiments, the first processing pass prepares a hierarchy of bounding boxes for a set of primitives that is traversed in the second processing pass to determine which primitives of the set of primitives to process (rasterise and render) for which rendering tiles that the render output is divided into.

The second processing pass can be, and in embodiments is, performed after the bounding box hierarchy has been generated in the first processing pass. In embodiments, the second processing pass traverses the (previously generated) bounding box hierarchy generated in the first processing pass to, when rendering a (and in embodiments each) tile of the render output, determine which primitives to process (rasterise and render) to generate the (respective) rendering tile, and processes (rasterises and renders) the determined primitives to generate the (respective) rendering tile of the render output.

In embodiments, the graphics processor (in the first processing pass) generates and writes out bounding box hierarchy information (data) that is representative of the bounding box hierarchy. Correspondingly, in embodiments, the graphics processor (in the second processing pass) reads in and processes (the) bounding box hierarchy information (data). In embodiments, the bounding box hierarchy information (data) is written out to, and/or read in from, a memory and/or cache system. That is, bounding box hierarchy information (data) may be stored in a cache system and/or memory.

Thus, in embodiments, the graphics processor comprises, and/or is in communication with, a memory. The memory may, for example, be a main memory of the overall graphics processing system that the graphics processor is part of. In embodiments, it is a memory that is off chip from the processor, i.e. an external (main) memory (external to the processor). The graphics processor may be in direct communication with the memory, or may communicate with the memory via a cache system. Thus, in embodiments, the graphics processor comprises a cache system that is operable to cache data stored in the memory for the graphics processor.

In embodiments, the graphics processor comprises a geometry processing control unit (e.g. tiler) that is operable to cause the first (geometry/tiling) processing pass to be performed, and that in embodiments, is a fixed function hardware unit (circuit). The geometry processing control unit (e.g. tiler) may perform some or all of the processing operations of the first (geometry/tiling) processing pass.

The graphics processor may comprise one or more, e.g. plural, programmable processing units (e.g. shader cores) that are operable to perform graphics processing operations by executing (e.g. shader) program instructions. There may be any suitable number of programmable processing units (e.g. shader cores), such as 1, 2, 4, 8, 16, 32 or another number. In embodiments, a (each) programmable processing unit (e.g. shader core) comprises one or more execution units (execution engines) that are operable to execute program instructions. In embodiments, a (each) programmable processing unit (e.g. shader core) further comprises an execution thread issuing circuit that is operable to issue execution threads to the (respective) one or more execution units for execution.

The first and/or second processing pass may be performed, at least in part, by the one or more programmable processing units (e.g. shader cores), e.g. executing one or more (e.g. shader) programs. In embodiments, the geometry processing control unit (e.g. tiler) is operable to distribute geometry processing tasks to (all of) the one or more programmable processing units (e.g. shader cores).

In embodiments, the first (geometry/tiling) processing pass is “packetized”, e.g. substantially as described in United Kingdom Patent Application No. 2217231.6, the entire contents of which is hereby incorporated by reference. Thus, in embodiments, the first processing pass includes a “frontend” process that generates packets of one or more primitives, and a “backend” process that processes packets generated in the frontend process to generate the hierarchy of bounding boxes. In embodiments, the backend process also writes out (stores) the bounding box hierarchy information, e.g. to (the) memory.

A (each) packet should, and in embodiments does, store geometry data for the one or more primitives of the (respective) packet. For example, a packet may store appropriate attributes, such as positions and varyings, for a set of vertices for the primitives that the packet relates to. A packet may (further) store a set of identifiers (indices) for the vertices that can be used to determine how the vertices are used for the primitives that the packet relates to. A packet may (also) store attributes and identifiers for the primitives, and/or other, e.g., state, information relating to the primitives that the packet relates to. Other arrangements would be possible.

Packets of primitives may be generated in any suitable manner. In embodiments, primitives are assembled and assigned to packets in order, e.g. in which they are defined for processing. In embodiments, a packet has a fixed capacity, e.g. an upper limit of vertices and/or primitives, and when the fixed capacity is reached, a new packet is started. There may be an upper limit of vertices of, for example, 64, 128 or 256 vertices, and/or an upper limit of primitives of, for example, 64, 128 or 256 primitives. Other numbers would be possible.

In embodiments, the primitives assigned to a packet are stored in the packet in the primitive processing order. Thus, in embodiments, a (each) packet comprises primitive order information indicating a primitive processing order for the primitives of the packet. In embodiments, the primitive order indicating information is used in the second processing pass so as to process (rasterise and render) primitives following the primitive processing order.

In embodiments, the frontend process further operates to allocate memory space for storing a packet (in (the) memory), e.g. and in embodiments, when starting a new packet. Thus, embodiments comprise allocating memory space for storing a packet, and storing the packet in the allocated memory space. Correspondingly, embodiments comprise fetching the packet from the allocated memory space, and processing the packet.

In embodiments, the frontend process further operates to keep track of the order in which packets are generated. Thus, embodiments comprise maintaining information indicating an order in which packets (for a drawcall/render output) are generated. In embodiments, the packet order indicating information is used in the second processing pass so as to process (rasterise and render) primitives following the packet order.

The packet order indicating information can take any suitable form. In embodiments, an array is maintained (e.g. in (the) memory), and when a new packet is started, a next entry of the packet array is allocated, such that the order in which entries appear in the packet array corresponds to the order in which packets were generated. Allocating an entry of the packet array may comprise writing a pointer to the array entry, wherein the pointer points to a memory location at which the corresponding packet is stored. The packet array may also store a packet bounding box for a (each) packet.

In embodiments, once a packet is completed, vertex (geometry) processing operations for the primitives/vertices in the packet are triggered. The triggered vertex (geometry) processing may comprise a position shading operation which transforms vertex position attributes from the model or user space that they are initially defined in, to the screen space that the render output is to be displayed in. The vertex (geometry) processing may also comprise transforming non-position vertex data (varyings) appropriately. In embodiments, once vertex (geometry) processing for a packet is completed, backend processing of the packet is performed.

In embodiments, the backend process processes packets to generate a hierarchy of bounding boxes, and may write out (store) information representative of the hierarchy of bounding boxes (to (the) memory). The backend process may process plural packets (for the same draw call/render output) at the same time, e.g. in parallel. It would also be possible for the frontend process to generate plural packets (for the same draw call/render output) at the same time, e.g. in parallel.

In embodiments, the backend process further operates to cull primitives from further processing. The culling may comprise, for example, front/back-face culling, frustum culling, and/or sample aware culling, etc.

A (the) hierarchy of bounding boxes can comprise any suitable set of (plural) bounding boxes that represent primitive positions (e.g. in screen space), and that can be used (in the second processing pass) to determine which of the primitives to process (rasterise and render) for which rendering tiles. A bounding box may bound only one primitive or plural primitives.

In embodiments, a (each) bounding box is a two-dimensional bounding box, e.g. a polygon such as a rectangle. In embodiments, a (each) bounding box is a two-dimensional bounding box defined in screen space (e.g. in x and y screen space dimensions). In embodiments, a (each) bounding box is determined from (and e.g. defined by) minimum and maximum (transformed) vertex positions (e.g. in x and y screen space dimensions) of the one or more primitives that the bounding box bounds. A (each) bounding box may be a minimum bounding box, or a less precise bounding box e.g. defined at the resolution of individual rendering tiles.

A (the) hierarchy of bounding boxes should, and in embodiments does, include bounding boxes that correspond to different “levels” of the hierarchy. The hierarchy of bounding boxes should, and in embodiments does, comprise a respective set of one or more bounding boxes for each “level” of plural levels of the hierarchy.

In embodiments, a (the) hierarchy of bounding boxes is arranged such that a (each) bounding box at a higher level of the hierarchy bounds a (respective) subset of the set of bounding boxes at a (the next) lower level of the hierarchy. A (each) higher level bounding box may be, for example and in embodiments, e.g. a rectangle, determined from (and e.g. defined by) minimum and maximum positions of the lower level bounding boxes which the higher level bounding box bounds (e.g. in x and y screen space dimensions).

A (each) higher level bounding box may bound any suitable number of bounding boxes of a set of bounding boxes at the next level of the hierarchy, such as two, four, eight, or another number of, bounding boxes. Similarly, a (the) hierarchy of bounding boxes may include any suitable total number of hierarchy levels, such as two, three, four, eight, or another number of, levels. In embodiments, there are at least two levels, such that a (each) primitive that the hierarchy of bounding boxes represents is bounded by at least two different bounding boxes at at least two different levels of the hierarchy.

In embodiments, a (the) hierarchy of bounding boxes comprises a set of primitive bounding boxes, wherein each primitive bounding box bounds a respective primitive. A (each) primitive bounding box in embodiments bounds only one (respective) primitive of a (respective) packet. In embodiments, the hierarchy of bounding boxes includes a respective primitive bounding box for each primitive of a set of primitives to be processed to generate the render output. In embodiments, the set of primitive bounding boxes represents a lowest level of the hierarchy of bounding boxes. In embodiments, a (each) primitive bounding box is stored (in (the) memory) in the corresponding packet, e.g. and in embodiments, together with attributes for the primitives of the packet.

In embodiments, a (the) hierarchy of bounding boxes comprises a set of one or more packet bounding boxes, wherein each packet bounding box bounds all of the one or more (e.g. plural) primitives of a respective packet. In embodiments, the set of bounding boxes includes a respective packet bounding box for each packet generated from a (the) set of primitives to be processed to generate the render output. In embodiments, the set of packet bounding boxes represents a higher level of the hierarchy of bounding boxes. A (each) packet bounding box may be stored (in (the) memory) in the corresponding packet, and/or in another data structure (in (the) memory).

In embodiments, bounding boxes at a hierarchy level higher than the packet level are generated by combining packet bounding boxes. Bounding boxes at a next (higher) hierarchy level may be generated by combining those higher level bounding boxes, and so on. Thus, the hierarchy of bounding boxes may comprise a set of one or more packet group bounding boxes, wherein each packet group bounding box bounds all of the primitives of a respective group of plural packets. The hierarchy of bounding boxes may further comprise a set of one or more even higher level bounding boxes, wherein each even higher level bounding box bounds all of the primitives of a respective group of plural packet groups (and so on). A (each) packet group/higher level bounding box may be stored (in (the) memory) in an appropriate data structure, e.g. and in embodiments, in the same data structure as a (each) corresponding packet bounding box.

In embodiments, a (the) hierarchy of bounding boxes comprises a set of one or more primitive group bounding boxes, wherein each primitive group bounding box bounds a respective group of one or more (e.g. plural) primitives within a (respective) packet. Where there are plural groups of primitives within a packet, a (each) primitive group bounding box in embodiments bounds only some but not all of the primitives of the (respective) packet of primitives. In embodiments, the hierarchy of bounding boxes includes a respective primitive group bounding box for each primitive group in each packet generated from a (the) set of primitives to be processed to generate the render output. In embodiments, the set of primitive group bounding boxes represents an intermediate level of the hierarchy of bounding boxes, in between the primitive and packet levels. In embodiments, a (each) primitive group/intermediate level bounding box is stored (in (the) memory) in the corresponding packet, e.g. and in embodiments, together with the corresponding primitive bounding box(es).

The hierarchy of bounding boxes may comprise only one intermediate level in between the primitive and packet levels. Alternatively, the hierarchy of bounding boxes may comprise plural intermediate levels in between the primitive and packet levels. In this latter case, intermediate level bounding boxes may be generated by combining primitive group bounding boxes, etc.

Bounding boxes at any one or more levels of the hierarchy of bounding boxes may be generated in accordance with the technology described herein. In embodiments, primitive group bounding boxes are generated in accordance with the technology described herein. Thus, in embodiments one or more primitive groups for a (and in embodiments each) packet are constructed by adding the primitives of the (respective) packet to the one or more groups, and a primitive group bounding box is generated for each such primitive group of the (respective) packet.

Thus, another embodiment of the technology described herein comprises a method of operating a tile-based graphics processor that is operable to generate a render output by building a hierarchy of bounding boxes to be used to identify primitives to process to generate a (each) rendering tile of the render output; the method comprising:
generating one or more packets of one or more primitives; and
processing the one or more packets to generate a hierarchy of bounding boxes representative of positions of primitives of the one or more packets;
wherein processing the one or more packets to generate the hierarchy of bounding boxes comprises:
   generating a lower level of the hierarchy of bounding boxes by generating, for each primitive of a packet, a primitive bounding box that bounds the respective primitive;
   generating a higher level of the hierarchy of bounding boxes by generating, for each packet, a packet bounding box that bounds all of the primitives of the respective packet; and
   generating an intermediate level of the hierarchy of bounding boxes by:
      constructing one or more groups of primitives by adding primitives of a packet to the one or more groups; and
      generating, for each group, a primitive group bounding box that bounds the primitives added to the respective group;
      wherein a (each) primitive is added to a group by:
         comparing a position of the (respective) primitive with a position of any (each) group currently under construction;
         selecting a group to add the (respective) primitive to based on the comparison; and
         adding the (respective) primitive to the selected group.

Another embodiment of the technology described herein comprises a tile-based graphics processor that is operable to generate a render output by building a hierarchy of bounding boxes to be used to identify primitives to process to generate a (each) rendering tile of the render output; the processor comprising:
a packet generating circuit configured to generate one or more packets of one or more primitives; and
a bounding box hierarchy generating circuit configured to process one or more packets generated by the packet generating circuit to generate a hierarchy of bounding boxes representative of positions of primitives of the one or more packets;
wherein the bounding box hierarchy generating circuit is configured to process one or more packets of one or more primitives to generate a hierarchy of bounding boxes by:
   generating a lower level of the hierarchy of bounding boxes by generating, for each primitive of a packet, a primitive bounding box that bounds the respective primitive;
   generating a higher level of the hierarchy of bounding boxes by generating, for each packet, a packet bounding box that bounds all of the primitives of the respective packet; and
   generating an intermediate level of the hierarchy of bounding boxes by:
      constructing one or more groups of primitives by adding primitives of a packet to the one or more groups; and
      generating, for each group, a primitive group bounding box that bounds the primitives added to the respective group;
      wherein a (each) primitive is added to a group by:
         comparing a position of the (respective) primitive with a position of any (each) group currently under construction;
         selecting a group to add the (respective) primitive to based on the comparison; and
         adding the (respective) primitive to the selected group.

These embodiments can, and in embodiments do, include any one or more or all of the optional features described herein, as appropriate.

In embodiments, a (each) group is constructed by adding one or more primitives to the group, in embodiments until a condition for completing construction of the group is reached. In embodiments, a (each) group has a maximum permitted number of primitives that can be added to the group, and construction of the group is completed when the maximum permitted number of primitives that can be added to the group have been added to the group. The maximum permitted number of primitives in a group may be 4, 8, 16, 32, 64, or another number of primitives.

In embodiments, there can be (and in embodiments are) plural groups under construction at any one time. In embodiments, there is a maximum permitted number of groups under construction at any one time. The maximum permitted number of groups under construction may be 2, 4, 8, or another number of groups.

In embodiments, each primitive (e.g. in a packet) is taken in order (in which the primitives in are defined for processing), and a group to add the primitive to is selected and the primitive is added to the selected group. In embodiments, each primitive in a packet is processed in the order in which the primitives in the packet are defined for processing (indicated by the primitive order information of the packet).

When a (and in embodiments each) primitive is to be added to a group, a (e.g. screen space) position of the primitive is compared with a (e.g. screen space) position of any group that is currently under construction, and a group to add the primitive to is selected based on the comparison.

When there are no primitive groups currently under construction, there will be no group positions to compare a primitive position with. In this case, in embodiments, construction of a new group is started, and the primitive added to the new group.

When there are one or more primitive groups currently under construction, in embodiments a primitive position is compared with a group position for each primitive group currently under construction. Thus, the comparison may comprise comparing the position of the primitive with each of one or more group positions.

A comparison of a position of a primitive with a position of a group under construction can be carried out in any suitable manner. In embodiments, a primitive bounding box that is representative of the position of the primitive is compared with a group bounding box that is representative of the position of the group under construction.

A (each) primitive bounding box that is compared may be a primitive bounding box that bounds a (respective) primitive, e.g. as described above.

In embodiments, a (each) group bounding box for a group under construction that is compared is a bounding box that bounds any (each) primitives that have already been added to the group under construction. To facilitate this, in embodiments, each time a primitive is added to a group, a group bounding box for the group may be updated so as to bound the primitive added to the group (as well as any primitives already added to the group). For example, when construction of a new group is started and a primitive is added to the new group, the group bounding box for the group may be set equal to the primitive bounding box for the primitive. Then, when another primitive is added to the group, the primitive bounding box for the another primitive may be used to expand the group bounding box for the group (and so on).

Using a primitive bounding box to expand a group bounding box may comprise determining whether a (each) maximum (e.g. x, y) position for the primitive bounding box is greater than the corresponding maximum position for the group bounding box, and when it is determined that the maximum position for the primitive bounding box is greater than the corresponding maximum position for the group bounding box, using the maximum position for the primitive bounding box as the new maximum position for the group bounding box. Using a primitive bounding box to expand a group bounding box may (further) comprise determining whether a (each) minimum (e.g. x, y) position for the primitive bounding box is less than the corresponding minimum position for the group bounding box, and when it is determined that the minimum position for the primitive bounding box is less than the corresponding minimum position for the group bounding box, using the minimum position for the primitive bounding box as the new minimum position for the group bounding box.

In embodiments, when construction of a group is completed, generation of the group bounding box for the group is complete, and the completed group bounding box may be written out, e.g. to (the) memory. For example, where the group bounding box is a primitive group bounding box for a primitive group of a packet, e.g. as described above, a completed primitive group bounding box may be written to the packet. In embodiments, information indicating the order in which group bounding boxes are completed (e.g. written out) is maintained. For example, completed primitive group bounding boxes for a packet may be stored in the packet in order. In embodiments, this group bounding box order indicating information is used in the second processing pass so as to process groups in order.

In embodiments, comparing a primitive bounding box with a group bounding box comprises determining whether the primitive bounding box overlaps the group bounding box.

In embodiments, the comparison comprises determining whether a primitive bounding box for a primitive overlaps a group bounding box for (exactly) one group currently under construction. In embodiments, when it is determined that a primitive bounding box for a primitive overlaps a group bounding box for (exactly) one group currently under construction, the (exactly) one group is selected and the primitive is added to the (exactly) one group. Alternatively, construction of the (exactly) one group may be completed, a new group may be started, and the primitive added to the new group.

In embodiments, the comparison comprises determining whether a primitive bounding box for a primitive overlaps a group bounding box for two or more groups currently under construction (in other words, determining whether a primitive bounding box for a primitive overlaps two or more group bounding boxes currently under construction). In embodiments, when it is determined that a primitive bounding box for a primitive overlaps a group bounding box for two or more groups currently under construction, before selecting a group and adding the primitive to the selected group, the number of groups currently under construction for which a group bounding box is overlapped by the primitive bounding box is reduced to less than two, i.e. to one or to zero. In embodiments, this is done so as to maintain primitive ordering.

The number of “overlapping groups” under construction can be reduced in any suitable manner. In embodiments, the number of “overlapping groups” under construction is reduced by completing the construction of at least one group, e.g. and in embodiments, before the maximum permitted number of primitives that can be added to the group have been added to the group. That is, in embodiments, the number of “overlapping groups” under construction is reduced by completing the construction of at least one group “early”.

In embodiments, in order for a (each) group to be eligible for early completion, the group must include a minimum permitted number of primitives. Thus, in embodiments it is determined whether a group includes greater than or equal to a minimum permitted number of primitives; and when it is determined that the group includes greater than or equal to the minimum permitted number of primitives, construction of the group can be (and in embodiments is) completed (early).

In embodiments, the number of “overlapping groups” under construction is (also or instead) reduced by merging at least two groups into a single merged group. Merging at least two groups into a single merged group may comprise combining the primitives already added to the at least two groups into the single merged group, and combining the group bounding boxes for the at least two groups into a single merged group bounding box for the single merged group (that bounds all of the primitives of the single merged group).

In embodiments, groups can only be (and in embodiments are only) merged into a single merged group if the combined number of primitives is less than or equal to the maximum permitted number of primitives that can be added to a group. Three or more groups could be merged into a single group. In embodiments, merging of groups is performed by merging a pair of groups into a single merged group. In embodiments, any merged group that is eligible for early completion may be completed (early).

In embodiments, the number of “overlapping groups” under construction is reduced by first completing the construction of any “overlapping groups” under construction that are eligible for early completion, and if two or more “overlapping groups” under construction that are not eligible for early completion remain, then merging these groups into one or more merged groups. In embodiments, any of these merged group that are then eligible for early completion are completed (early).

Thus, in embodiments it is determined whether any “overlapping group” under construction includes greater than or equal to a minimum permitted number of primitives; and when it is determined that an “overlapping group” under construction includes greater than or equal to the minimum permitted number of primitives, construction of that “overlapping group” is completed (early). It may then be determined whether there are two or more “overlapping groups” under construction (that each include less than the minimum permitted number of primitives); and when this is the case, at least two of the two or more “overlapping groups” under construction may be merged.

The minimum permitted number of primitives in a group may be any suitable number, such as 2, 4, 8, 16, 32, 64, or another number of primitives. In embodiments, the minimum permitted number of primitives in a group is less than or equal to half of the maximum permitted number of primitives that a group can contain. This can then ensure that merging a pair of groups that each include less than the minimum permitted number of primitives results in a single merged group that has less than or equal to the maximum permitted number of primitives.

In embodiments, once the number of “overlapping groups” under construction has been reduced to less than two, i.e. to one or to zero, the primitive is added to a selected group. In embodiments, if the number of “overlapping groups” under construction has been reduced to one, the primitive is added to that group. In embodiments, if the number of “overlapping groups” under construction has been reduced to zero, a new primitive group is started and the primitive is added the new primitive group.

In embodiments, the comparison comprises determining whether a primitive bounding box for a primitive does not overlap a group bounding box for any group currently under construction. In embodiments, when it is determined that a primitive bounding box for a primitive does not overlap a group bounding box for any group currently under construction, the group that the primitive is added to depends on the number of groups that are currently under construction.

In embodiments, as mentioned above, if there are no groups currently under construction, the primitive bounding box for a primitive will not overlap a group bounding box for any group currently under construction, and in this case construction of a new group is in embodiments started, and the primitive added to the new group.

In embodiments, if there is at least one group currently under construction but less than the maximum permitted number of groups currently under construction (and the primitive bounding box for a primitive does not overlap a group bounding box for any group currently under construction), in embodiments construction of a new group is started, and the primitive added to the new group.

In embodiments, if there is the maximum permitted number of groups currently under construction (and the primitive bounding box for a primitive does not overlap a group bounding box for any group currently under construction), it is determined whether there is a group under construction that is eligible for early completion (e.g. includes greater than or equal to the minimum permitted number of primitives). In embodiments, if there is a group under construction that is eligible for early completion, construction of that group is completed (early), construction of a new group is started, and the primitive added to the new group.

In embodiments, if there is the maximum permitted number of groups currently under construction (and the primitive bounding box for a primitive does not overlap a group bounding box for any group currently under construction) (and there are no groups under construction that are eligible for early completion), the group with the closest group bounding box to the primitive bounding box is determined, and the primitive is added that group. Alternatively, the number of groups currently under construction may be reduced by merging/completing groups e.g. as described above, construction of a new group may then be started, and the primitive added to the new group.

Once a bounding box hierarchy has been generated (in the first processing pass), the hierarchy may be traversed (in the second processing pass) to determine which primitives to process for which rendering tiles.

To facilitate this, in embodiments, the graphics processor comprises a rendering circuit that is operable to process primitives to generate rendering tiles of the render output, and a primitive providing circuit that traverses the bounding box hierarchy (generated in the first processing pass) to determine primitives to process for a rendering tile, and provides the determined primitives to the rendering circuit for processing (in the second processing pass).

Thus, in embodiments, (in the second processing pass) the primitive providing circuit traverses the bounding box hierarchy (generated in the first processing pass) to determine which primitives to process (rasterise and render) to generate a rendering tile and provides the determined primitives to the rendering circuit, and the rendering circuit processes (rasterises and renders) the primitives provided by the primitive providing circuit to generate the respective rendering tile.

The rendering circuit may include a rasteriser and a fragment renderer. In embodiments, the rasteriser receives primitives from the primitive providing circuit, rasterises the primitives to fragments, and provides the fragments to the fragment renderer for processing. In embodiments, the fragment renderer is operable to perform fragment rendering to generate rendered fragment data, and may perform any appropriate fragment processing operations in respect of fragments generated by the rasteriser, such as texture mapping, blending, shading, etc.

In embodiments, the tile-based graphics processor comprises one or more tile buffers that store rendered data for a rendering tile being rendered by the tile-based graphics processor, until the tile-based graphics processor completes the rendering of the rendering tile. In embodiments, rendered fragment data generated by the fragment renderer is written to a tile buffer.

The tile buffer should be, and in embodiments is, provided local to (i.e. on the same chip as) a (the) tile-based graphics processor, for example, and in embodiments, as part of RAM that is located on (local to) the graphics processor (chip). The tile buffer may accordingly have a fixed storage capacity, for example corresponding to the data (e.g. for an array or arrays of sample values) that the tile-based graphics processor needs to store for (only) a single rendering tile until the rendering of that tile is completed.

Once a rendering tile is completed by the tile-based graphics processor, rendered data for the rendering tile in embodiments is written out from the tile buffer to other storage that is in embodiments external to (i.e. on a different chip to) the tile-based graphics processor, such as (a frame buffer in) the (main) memory, for use. The graphics processor in embodiments includes a write out circuit coupled to the tile buffer for this purpose.

In embodiments, traversing the hierarchy of bounding boxes to determine the primitives to process to generate a rendering tile comprises determining whether the rendering tile overlaps a (and in embodiments each) “highest-level” bounding box (at the highest level of the hierarchy). In embodiments, when it is determined that the rendering tile overlaps a highest-level bounding box, it is determined whether the rendering tile overlaps a (and in embodiments each) “next highest-level” bounding box (at the next highest level of the hierarchy) that is bounded by the highest-level bounding box.

In embodiments, this traversal process is performed, as appropriate, for each level of the hierarchy, and thus may proceed, as appropriate, to the lowest (primitive) level of the hierarchy. Thus, in embodiments, when it is determined that the rendering tile overlaps a higher-level bounding box, it is determined whether the rendering tile overlaps a (and in embodiments each) lower level bounding box that is bounded by the higher-level bounding box.

In embodiments, when it is determined that the rendering tile overlaps a primitive bounding box (at the lowest level of the hierarchy), it is determined that the primitive that is bounded by the primitive bounding box is a primitive to be processed to generate the rendering tile. The primitive may thus be provided to the rendering circuit for processing (e.g. rasterising and rendering).

In embodiments, when it is determined that a rendering tile does not overlap a bounding box (at any level of the hierarchy), it is determined that any primitive that is bounded by the bounding box is not a primitive to be processed to generate the rendering tile (i.e. does not need to be processed to generate the rendering tile).

Thus, in embodiments, traversing the hierarchy of bounding boxes comprises iteratively testing a rendering tile (area) against progressively smaller bounding boxes of the hierarchy of bounding boxes. In embodiments, traversing the hierarchy of bounding boxes to determine the primitives to process to generate a rendering tile comprises testing the rendering tile (area) against a larger (largest) bounding box of the hierarchy of bounding boxes to determine if the rendering tile (area) covers the larger (largest) bounding box (at least in part). If the rendering tile (area) does cover (at least in part) the larger (largest) bounding box, then the rendering tile (area) may be tested against a (each) smaller bounding box of the hierarchy of bounding boxes that the larger (largest) bounding box encompasses to determine if the rendering tile (area) covers the (respective) smaller bounding box (at least in part). This process may be repeated for a (each) bounding box encompassed by a bounding box found to be at least partially covered by the rendering tile (area), until a smallest bounding box size is reached. If the rendering tile (area) is found to cover (at least in part) a smallest bounding box, then it may be determined that any primitive bounded by the smallest bounding box is a primitive to be processed to generate the rendering tile.

In embodiments, as mentioned above, an intermediate, primitive group level of the hierarchy is generated in accordance with the technology described herein.

Thus, in embodiments, traversing the hierarchy of bounding boxes to identify primitives to process to generate a (each) rendering tile comprises: testing the (respective) rendering tile against bounding boxes of the hierarchy of bounding boxes to determine whether the (respective) rendering tile overlaps (at least partially) the bounding boxes; when it is determined that the (respective) rendering tile overlaps a packet bounding box that bounds all primitives of a packet of primitives, testing the (respective) rendering tile against a (each) primitive group bounding box that bounds a group of (in embodiments, some but not all) primitives of the packet of primitives; when it is determined that the (respective) rendering tile overlaps a primitive group bounding box that bounds a group of (in embodiments, some but not all) primitives of a packet of primitives, testing the (respective) rendering tile against a (each) primitive bounding box that bounds a (single) primitive of the group of primitives; and when it is determined that the (respective) rendering tile overlaps a primitive bounding box that bounds a (single) primitive, identifying the primitive as a primitive to process to generate the rendering tile.

In embodiments, the second processing pass comprises (the primitive providing circuit) determining that a primitive is a primitive to be processed (rasterised and rendered) to generate a rendering tile using at least a packet bounding box, a primitive group bounding box (generated in accordance with the technology described herein), and a primitive bounding box that bound that (same) primitive.

In embodiments, a (each) primitive group bounding box is stored (in (the) memory) in the corresponding packet (that contains the group of primitives that the primitive group bounding box bounds); and when it is determined that a rendering tile overlaps a packet bounding box for a packet: the packet is loaded (from (the) memory) and the primitive group bounding box(es) stored in the packet are used (by the primitive providing circuit) to determine whether the rendering tile overlaps a (each) primitive group bounding box.

In embodiments, a (each) primitive bounding box is (also) stored (in (the) memory) in the corresponding packet (that contains the primitive that the primitive bounding box bounds); and when it is determined that a rendering tile overlaps a packet bounding box for a packet: the packet is loaded (from (the) memory) and the primitive bounding box(es) stored in the packet are used (by the primitive providing circuit) to determine whether the rendering tile overlaps a (each) primitive bounding box (for which the corresponding primitive group bounding box has been found to be overlapped by the rendering tile).

The technology described herein can be implemented in any suitable system, such as a suitably configured micro-processor based system. In embodiments, the technology described herein is implemented in a computer and/or micro-processor based system. The technology described herein is in embodiments implemented in a portable device, such as, and in embodiments, a mobile phone or tablet.

The technology described herein is applicable to any suitable form or configuration of graphics processor and graphics processing system, such as graphics processors (and systems) having a “pipelined” arrangement (in which case the graphics processor executes a rendering pipeline).

In embodiments, the various functions of the technology described herein are carried out on a single data processing platform that generates and outputs data, for example for a display device.

As will be appreciated by those skilled in the art, the graphics processor may be part of a graphics processing system that may include, e.g., and in embodiments, a host processor that, e.g., executes applications that require processing by the graphics processor. The host processor will send appropriate commands and data to the graphics processor to control it to perform graphics processing operations and to produce graphics processing output required by applications executing on the host processor. To facilitate this, the host processor should, and in embodiments does, also execute a driver for the processor and optionally a compiler or compilers for compiling (e.g. shader) programs to be executed by (e.g. an (programmable) processing unit of) the processor.

The processor may also comprise, and/or be in communication with, one or more memories and/or memory devices that store the data described herein, and/or store software (e.g. (shader) program) for performing the processes described herein. The processor may also be in communication with a host microprocessor, and/or with a display for displaying images based on data generated by the processor.

The technology described herein can be used for all forms of input and/or output that a graphics processor may use or generate. For example, the graphics processor may execute a graphics processing pipeline that generates frames for display, render-to-texture outputs, etc., The output data values from the processing are in embodiments exported to external, e.g. main, memory, for storage and use, such as to a frame buffer for a display.

The various functions of the technology described herein can be carried out in any desired and suitable manner. For example, the functions of the technology described herein can be implemented in hardware or software, as desired. Thus, for example, the various functional elements, stages, and “means” of the technology described herein may comprise a suitable processor or processors, controller or controllers, functional units, circuitry, circuit(s), processing logic, microprocessor arrangements, etc., that are operable to perform the various functions, etc., such as appropriately dedicated hardware elements (processing circuit(s)) and/or programmable hardware elements (processing circuit(s)) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuit(s), etc., if desired.

Furthermore, any one or more or all of the processing stages of the technology described herein may be embodied as processing stage circuitry/circuits, e.g., in the form of one or more fixed-function units (hardware) (processing circuitry/circuits), and/or in the form of programmable processing circuitry/circuits that can be programmed to perform the desired operation. Equally, any one or more of the processing stages and processing stage circuitry/circuits of the technology described herein may be provided as a separate circuit element to any one or more of the other processing stages or processing stage circuitry/circuits, and/or any one or more or all of the processing stages and processing stage circuitry/circuits may be at least partially formed of shared processing circuitry/circuits.

Subject to any hardware necessary to carry out the specific functions discussed above, the components of the data processing system can otherwise include any one or more or all of the usual functional units, etc., that such components include.

It will also be appreciated by those skilled in the art that all of the described embodiments of the technology described herein can include, as appropriate, any one or more or all of the optional features described herein.

The methods in accordance with the technology described herein may be implemented at least partially using software e.g. computer programs. It will thus be seen that when viewed from further embodiments the technology described herein provides computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processing system may be a microprocessor, a programmable FPGA (Field Programmable Gate Array), etc.

The technology described herein also extends to a computer software carrier comprising such software which when used to operate a data processor, renderer or other system comprising a data processor causes in conjunction with said data processor said processor, renderer or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible, non-transitory medium, such as a computer readable medium, for example, diskette, CD ROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

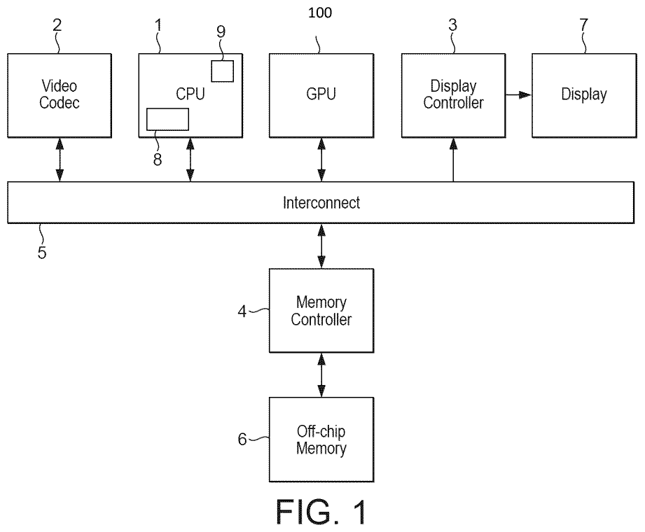

FIG. 1 shows an exemplary graphics processing system in which embodiments of technology described herein may be implemented.

The exemplary graphics processing system shown in FIG. 1 comprises a host processor comprising at least one central processing unit (CPU) 1, a graphics processor (graphics processing unit (GPU)) 100, a video codec 2, a display controller 3, and a memory controller 4. As shown in FIG. 1, these units communicate via an interconnect 5 and have access to an off-chip memory system (memory) 6. In this system, the graphics processor 100, the video codec 2 and/or CPU 1 will generate frames (images) to be displayed and the display controller 3 will then provide frames to a display 7 for display.

In use of this system, an application 8, such as a game, executing on the host processor (CPU) 1 will, for example, require the display of frames on the display 7. To do this the application 8 will send appropriate commands and data to a driver 9 for the graphics processor 100 that is executing on the at least one CPU 1. The driver 9 will then generate appropriate commands and data to cause the graphics processor 100 to render appropriate frames for display and store those frames in appropriate frame buffers, e.g. in main memory 6. The display controller 3 will then read those frames into a buffer for the display from where they are then read out and displayed on the display panel of the display 7.

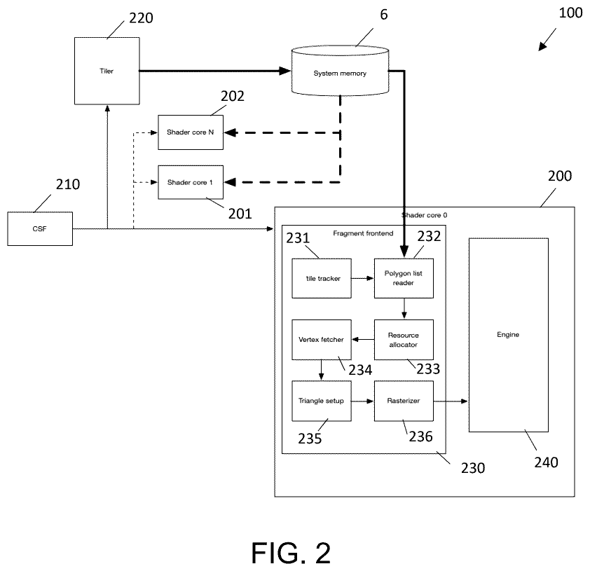

FIG. 2 shows a typical tile-based graphics processor 100 in more detail. As shown in FIG. 2, the tile-based graphics processor 100 includes a command stream frontend (CSF) 210, a tiler (geometry processing control unit) 220, and a set of shader cores 200, 201, 202. FIG. 2 illustrates one of the shader cores 200 in greater detail than the others 201, 202, but each shader core of the graphics processor 100 has substantially the same configuration.

The command stream frontend 210 receives commands and data from the driver 9 (directly, or via data structures in memory), and distributes subtasks for execution to the tiling unit 220 and to the shader cores 200, 201, 202 appropriately.

In a tile-based rendering system the render output (e.g. frame for display) is divided into a plurality of tiles for rendering. Typically, each tile is 16×16, 32×32, or 64×64 data elements (sampling positions) in size, with the render output being divided into however many such tiles as are required for the render output size and shape that is being used. The tiles are rendered separately to generate the render output. To do this, for each draw call that is received to be processed, the tile-based graphics processor 100 operates to sort the primitives (polygons) for the draw call according to which tiles they should be processed for.

In order to facilitate this, in a typical tile-based graphics processor, the tiling unit 220 is operable to perform a first processing pass in which lists of primitives to be processed for different regions of the render output are prepared. These “primitive lists” (which can also be referred to as “tile lists” or “polygon lists”) identify the primitives to be processed for the region in question.

As part of this processing pass, the tiler 220 and/or command stream frontend (CSF) 210 may assemble primitives from vertex data, and request vertex processing tasks to be performed by the set of shader cores 200, 201, 202 to generate processed (transformed) vertex data that the tiling unit 220 uses to prepare primitive lists. This “vertex shading” operation may comprise, for example, transforming vertex position attributes from the model space that they are initially defined for to the screen space that the output of the graphics processing is to be displayed in.

Once vertex processing and tiling has been completed, the transformed geometry and the primitive lists are written back to the main memory 6, and the first processing pass is complete.

A second processing pass is then performed for the render output, wherein each of the rendering tiles is rendered separately. In this processing pass, the fragment frontend 230 of a shader core 200 receives fragment processing tasks from the command stream frontend (CSF) 210, and in response, tile tracker 231 schedules the rendering work that the shader core needs to perform in order to generate a tile. Primitive list reader 232 then reads the appropriate primitive list(s) for that tile from the memory 6 to identify the primitives that are to be rendered for the tile.

Resource allocator 233 then configures various elements of the graphics processor 100 for rendering the primitives that the primitive list reader 232 has identified are to be rendered for the tile. For example, the resource allocator 233 may appropriately configure a local tile buffer for storing output data for the tile being rendered.

Vertex fetcher 234 then reads the appropriate processed (transformed) vertex data for primitives to be rendered from the memory 6, and provides the primitives (i.e. their processed vertex data) to triangle set-up unit 235. The triangle set-up unit 235 performs primitive setup operations to setup the primitives to be rendered. This includes determining, from the vertices for the primitives, edge information representing the primitive edges. The edge information for the primitives is then passed to the rasteriser 236.

When the rasteriser 236 receives a graphics primitive for rendering (i.e. including its edge information), it rasterises the primitive to sampling points and generates one or more graphics fragments having appropriate positions (representing appropriate sampling positions) for rendering the primitive.

Fragments generated by the rasteriser 236 may then be subject to “culling” operations, such as depth testing, to see if any fragments can be discarded (culled) at this stage. Execution threads are then issued to execution engine 240 for processing fragments that have survived the culling stage.

The execution engine 240 executes a shader program for each execution thread issued to it to generate appropriate render output data, including colour (red, green and blue, RGB) and transparency (alpha, a) data. The execution engine 240 may perform fragment processing (rendering) operations such as texture mapping, blending, shading, etc. on the fragments. Output data generated by the execution engine 240 is then written appropriately to the tile buffer.

Once a tile has been processed, its data is exported from the tile buffer to the main memory 6 (e.g. to a frame buffer in the main memory 6) for storage, and the next tile is then processed, and so on, until sufficient tiles have been processed to generate the entire render output (e.g. frame (image) to be displayed). The next render output (e.g. frame) may then be generated, and so on.

It has been recognised that in tile-based graphics processing arrangements such as described above, the primitive lists must typically be generated and written out in serial order, e.g. so as to preserve the order in which the primitives are intended to be processed. This means that the primitive list writing process must typically operate in a serial fashion. This can create a performance “bottleneck” in the graphics processing pipeline, and can also hinder scaling to different tiling performance levels.

United Kingdom Patent Application No. 2316170.6 describes tile-based graphics processing in which bounding box information is written out in the first processing pass, and then in the second processing pass, the bounding box information is used to determine which primitives to process (rasterise and render) for which rendering tiles. As bounding box generation and writing out processes can be parallelised in a straightforward manner, this can facilitate improved performance, as well as scaling to different performance levels.

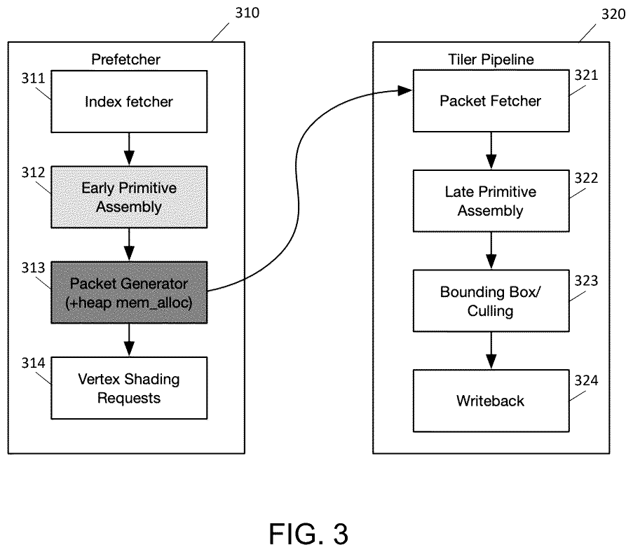

FIG. 3 schematically illustrates a first processing pass that generates and writes out bounding box information in accordance with embodiments of the technology described herein. This process may be performed by a tiling unit (geometry processing control unit) 220 of the graphics processor 100 in a pipelined manner. As shown in FIG. 3, the pipeline includes a prefetcher pipeline 310 (“frontend”) that generates “packets” and triggers vertex shading operations in respect of generated packets, and a tiler pipeline 320 (“backend”) that processes the packets generated by the prefetcher pipeline 310.

The prefetcher pipeline 310 includes index fetcher 311 which fetches and outputs a sequence (stream) of indices from a stored vertex index array defined and provided for the render output being generated, and provides the sequence of indices to early primitive assembly stage 312. Early primitive assembly stage 312 assembles complete primitives from the stream of indices in accordance with primitive configuration information that defines the type of primitives to be assembled (e.g. whether the assembled primitives are to be in the form of triangles, triangle strips, triangle fans, points or lines, etc.), and outputs a sequence of complete assembled primitives to packet generation stage 313.

The packet generation stage 313 operates to generate packets comprising vertices of assembled primitives. The packet generation stage 313 allocates vertices and primitives that are received from the earlier primitive assembly 312 to a respective packet(s) in turn. The packet generation stage 313 also allocates appropriate space in memory 6 for storing the packets.

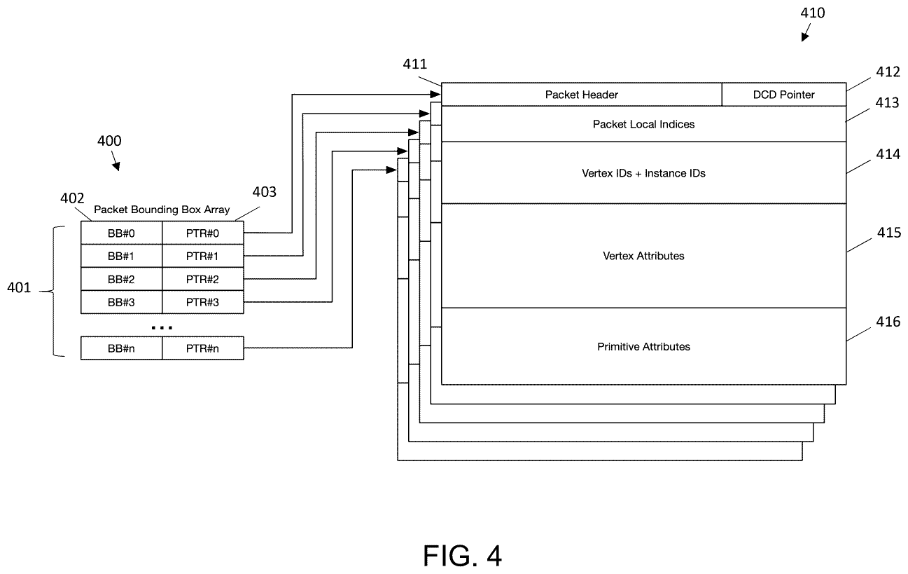

FIG. 4 illustrates a memory layout for a packet 410 that may be allocated by the packet generation stage 313. As illustrated in FIG. 4, in this embodiment, a packet 410 includes header information 411 that includes a pointer to the draw call descriptor (DCD) 412 for the draw call that the packet represents. The packet 410 further includes body information comprising identifiers 414 for the vertices that the packet contains, and indices 413 that reference the vertices to define the primitives that the packet contains. The packet 410 further includes vertex attribute data 415 for the vertices that the packet contains, and primitive attribute data 416 for the primitives that the packet contains.

As illustrated in FIG. 4, the packet generation stage 313 may also maintain an array 400 to keep track of the packets it has generated, and the order in which packets have been generated (for a particular drawcall/render output). As illustrated in FIG. 4, the packet array 400 includes a number of entries 401 that each include a respective pointer 403 pointing to the respective packet 410 in memory 6. Each entry 401 also includes packet bounding box information 402, which will be described below.

In the present embodiment, each packet has a maximum permitted number of vertices of 256 vertices, and a maximum permitted number of primitives of 256 primitives. Other maximum numbers, such as 64, 128, would be possible. Primitives are assigned to packets in turn, and a new packet is started once the maximum permitted number of vertices or the maximum permitted number of primitives is reached. Primitives are thus assigned to packets in the order in which the primitives are defined for processing (e.g. by driver 9). Each time a new packet is started, the packet generation stage 313 allocates the next entry in the packet array 400, such that the order in which packets appear in the packet array 400 corresponds to the order in which the packets were generated (and the order in which primitives appear in a packet corresponds to the order in which the primitives were specified for processing).

Returning to FIG. 3, once a packet has been filled up, vertex shading of position attributes for the vertices that have been included in the vertex packet is requested 314. In response to the vertex shading requests 314, the position shading for a packet is performed by the shader cores 200 executing an appropriate shader program, which generates and stores the vertex shaded (transformed) positions 415 for the vertices of the packet in the packet 410. Then, once the transformed vertex positions for the vertices of the packet have been generated and stored, they can then be processed by the tiler pipeline 320 (“backend”).

With reference to FIG. 3, packet fetcher 321 of the tiler pipeline 320 (“backend”) loads packets (when they are ready) from memory 6 into a vertex buffer.

Late primitive assembly stage 322 may associate each assembled primitive in sequence with the corresponding transformed positions for the vertices for the primitive in question from the vertex buffer, and store appropriate primitive attribute information 416 in the packet 410.

As shown in FIG. 3, bounding box generation stage 323 then generates bounding boxes for the assembled primitives of a packet, and also operates to cull primitives from further processing on the basis of their (potential) visibility. This culling may comprise, for example, front/back-face culling, frustum culling, and/or sample aware culling, etc.

The bounding box generation uses the provided positions for the assembled primitives to generate an appropriate, e.g. minimum, bounding box for each primitive defined by a packet 410. These “primitive bounding boxes” may be stored with the primitive attribute information 416 in the packet 410. Alternatively, the primitive bounding boxes could be stored in a dedicated region of the packet 410.

The bounding box generation stage 323 also generates for each packet, a “packet bounding box” that bounds all of the primitive bounding boxes within the packet 410. A packet bounding box may, for example, be generated by determining the maximum and minimum x and y values for the primitive bounding boxes within the packet in question. The packet bounding box for a packet is stored in the corresponding entry 402 of the packet array 400.

Once the bounding boxes have been generated, they may be written out 324 to memory 6. The bounding box information may be optionally compressed before being written out.

Thus, in effect, a “hierarchy” of bounding boxes is generated: a “lowest” hierarchy level comprising a primitive bounding box for each primitive, and a “higher” hierarchy level comprising a packet bounding box for each packet.

As described in United Kingdom Patent Application No. 2316170.6, a higher bounding box hierarchy level may be generated by grouping packets into groups of packets, and generating a higher-level bounding box for each group of packets that bounds all of the packet bounding boxes for the group. One or more further higher levels of the bounding box hierarchy may be generated in an analogous manner, e.g. by grouping groups of packets and generating bounding boxes for groups of groups of packets, and so on.

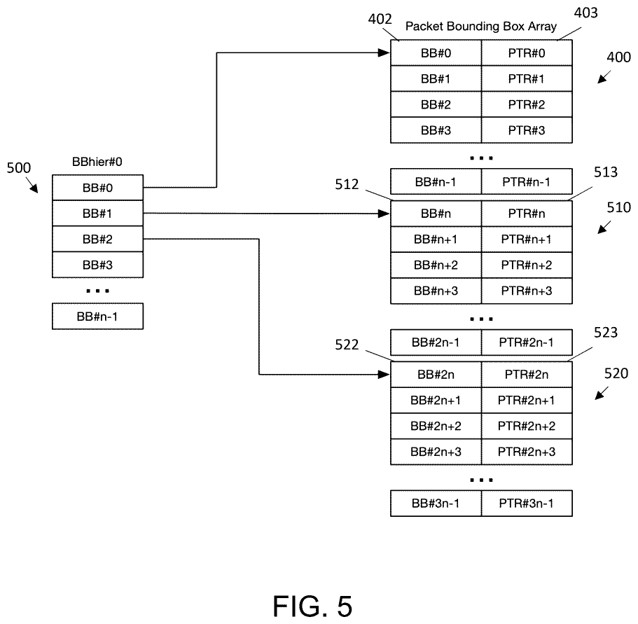

For example, FIG. 5 illustrates hierarchical bounding box information stored in memory 6. As illustrated in FIG. 5, a bounding box hierarchy array 500 may be maintained, with each entry of the array comprising a pointer pointing to another array that defines bounding boxes for a respective level of the bounding box hierarchy.

As shown in FIG. 5, the first entry of the bounding box hierarchy array 500 may point to the packet array 400 that includes pointers 403 that point to respective packets 410 stored in memory 6, and packet bounding box information 402 that defines the respective packet bounding boxes.

The next entry of the bounding box hierarchy array 500 may then point to a higher-level array 510, each entry of which comprising a respective “higher level” bounding box 512, and pointers 513 pointing to the packet array 400 entries for the packet bounding boxes from which the respective “higher level” bounding box was generated. The next entry of the bounding box hierarchy array 500 may point to a still higher-level array 520 with entries comprising respective “still higher level” bounding boxes 522, and pointers 523 pointing to the corresponding entries in the next lower level array 510, and so on, up to a “highest” level for the draw call/render output in question.

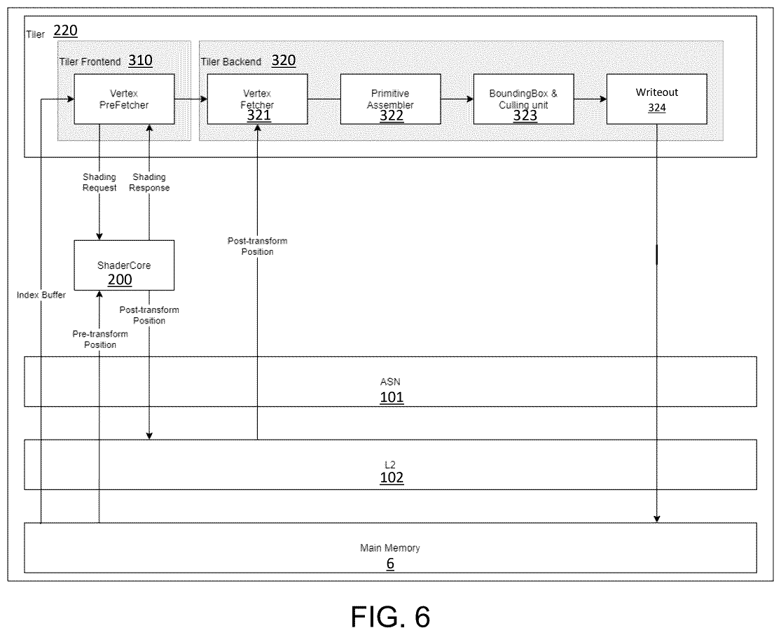

FIG. 6 shows schematically an overview of the geometry (tiling) process of the present embodiment. As illustrated in FIG. 6, tiler frontend 310 of tiler 220 uses vertex indices received from memory 6 to assemble primitives and generate packets, and issues requests for vertex processing of packets to shader cores 200. In response to the requests, shader cores 200 read in vertex data from memory 6, transform the vertex data, and write out transformed vertex data to packets via L2 cache 102 and ASN 101. When vertex processing is completed, shader cores 200 signal to the tiler frontend 310 that vertex processing is completed.

The vertex fetcher 321 of the tiler backend 320 then fetches the transformed vertex data, and passes it to the remaining processing stages of the tiler backend 320. FIG. 6 illustrates the transformed vertex data being fetched from L2 cache 102, but it will be appreciated that the transformed vertex data may need to be fetched from memory 6, e.g. depending on the capacity and status of the L2 cache 102. Tiler backend then assembles primitives 322, performs culling and bounding box generation 323, and writes out 324 bounding box information to memory 6.

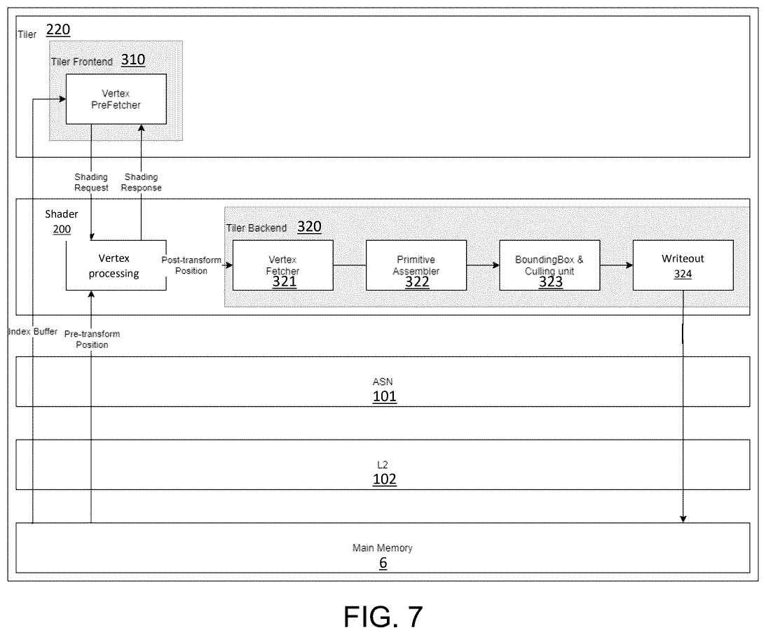

Although in this embodiment, both the tiling frontend 310 and backend 320 processes are performed by hardware units of a tiler 220, other arrangements are possible. For example, FIG. 7 shows schematically an embodiment in which the tiling frontend process 310 is performed in hardware by tiler (geometry processing control unit) 220, and the tiler backend process 320 is performed in software by shader cores 200 executing appropriate shader programs.

As illustrated in FIG. 7, in this embodiment, tiler frontend 310 of tiler 220 uses vertex indices received from memory 6 to assemble primitives and generate packets, and issues requests for vertex processing of packets to shader cores 200. In response to the requests, shader cores 200 read in vertex data from memory 6, and (their execution engines 240) execute vertex shading programs to transform the vertex data.

When vertex processing for a packet is completed, (execution engines 240 of) shader cores 200 execute shader programs to perform the tiling backend process 320 for the packet. Thus, the transformed vertex data 321 for a packet is used to assemble primitives 322, culling and bounding box generation 323 is performed, and then bounding box information is written out 324.

Alternatively, the tiling frontend process 310 may be performed by tiler (geometry processing control unit) 220, and the tiler backend process 320 may be performed by (hardware) circuits that are integrated with the shader cores 200. In this embodiment, a shader core 200 comprises an execution engine 240 and a tiler backend circuit 320 that includes a packet fetcher circuit 321, a primitive assembly circuit 322, a bounding box generation circuit 323 and a writeout circuit 324 configured to perform the backend processes described above.

Since, in these embodiments, the transformed vertex data is generated by, and subsequently processed by, shader cores 200, the transformed vertex data may remain in L1/L2 cache 102, and the need for the transformed vertex data to be written out to memory 6 and then read back into the tiler 220 at the start of the backend process 320 (e.g. as may be done in the embodiment of FIG. 6) can be avoided. This can accordingly reduce memory bandwidth requirements.

Once a bounding box hierarchy has been generated, it is used in a subsequent fragment processing pass to generate respective tiles of the overall render output. In the present embodiment, these “fragment stages” start with a hierarchical bounding box reader stage reading the bounding box hierarchy. The hierarchical bounding box reader stage thus, in embodiments, replaces the primitive list reader 232 described above.

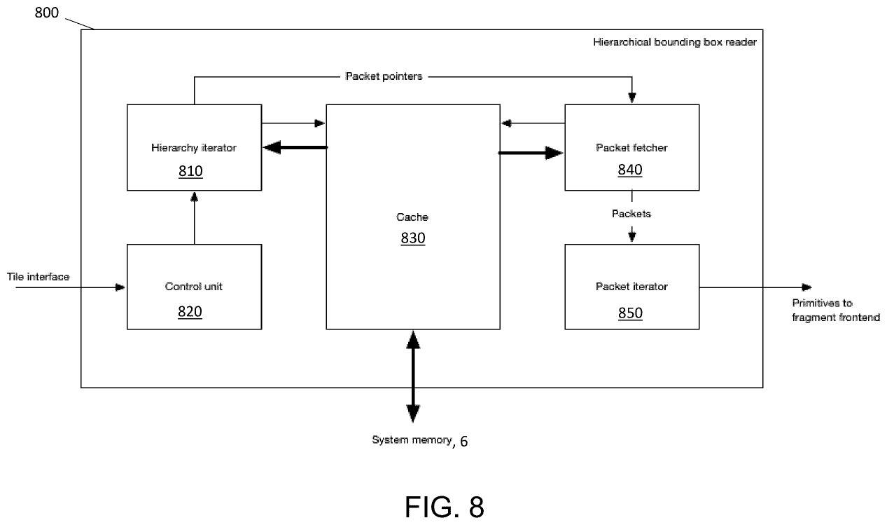

FIG. 8 illustrates schematically the hierarchical bounding box reader 800 according to the present embodiment. The hierarchical bounding box reader 800 reads the bounding box hierarchy data from memory 6 into cache 830, and control unit 820 controls hierarchy iterator 810 to iterate through the bounding box hierarchy data in order to identify packets whose packet bounding box overlaps the current tile being processed. The iteration is such that packets will be identified in the order in which they were generated.

In the present embodiment, this involves first determining whether the current tile overlaps a highest-level bounding box of the hierarchy. For each highest-level bounding box that the current tile is found to overlap, next lower-level bounding box information is used to determine whether the current tile overlaps a next lower-level bounding box of the hierarchy that is covered by the respective highest-level bounding box, and so on, until the packet bounding box hierarchy level is reached.

When a packet whose packet bounding box overlaps the current tile is identified, packet fetcher 840 may fetch the packet data into cache 830, and then packet iterator 850 may identify primitives in the packet whose primitive bounding box overlaps the current tile being processed. The iteration may be such that primitives will be identified in the order in which they were originally specified.

When a primitive whose primitive bounding box overlaps the current tile is identified, the primitive is output by the hierarchical bounding box reader 800 to the subsequent stages of the fragment processing pipeline. The primitive may thus be passed to the resource allocator 233 for processing, e.g. as described above. The primitive may thus be rasterised and rendered appropriately.

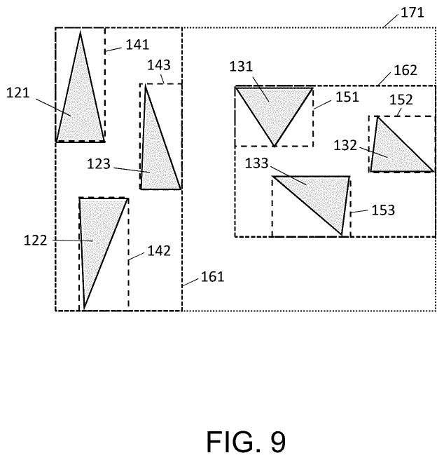

FIG. 9 illustrates one way in which a hierarchy of bounding boxes could be arranged for an exemplary set of primitives defined for a render output (frame). It will be appreciated that FIG. 9 is simplified for illustrative purposes, and in practice there may be many more primitives and bounding boxes defined for a render output. FIG. 9 shows a first set of primitives 121, 122, 123 that are included in a first packet generated by tiler frontend 310, and a second set of primitives 131, 132, 133 that are included in a second packet generated by tiler frontend 310.

As illustrated in FIG. 9, in this arrangement, a lowest-level bounding box hierarchy level comprises primitive bounding boxes 141, 142, 143, 151, 152, 153 that are each drawn (in screen space) around a respective primitive, and that are stored in primitive attribute information 416 of respective packets 410 in memory 6. The next hierarchy level comprises packet bounding boxes 161, 162 that are each drawn (in screen space) around all of the primitives in a respective packet, and that are stored in packet array 400 in memory 6. The next hierarchy level comprises packet group bounding boxes 171 that are each drawn (in screen space) around a respective group of packet bounding boxes 161, 162, and that are stored in higher-level array 510 in memory 6. A next hierarchy level may comprise higher-level bounding boxes (not shown) that are each drawn (in screen space) around a respective group of packet group bounding boxes, and stored in still higher-level array 520, and so on.

In this example, the hierarchical bounding box reader 800 may proceed by testing packet group bounding box 171 to determine whether a current rendering tile overlaps packet group bounding box 171, and if the current rendering tile does overlap packet group bounding box 171, then test packet bounding boxes 161, 162 that packet group bounding box 171 is drawn around to determine whether the current rendering tile overlaps those packet bounding boxes 161, 162. If the current rendering tile does overlap a packet bounding box 161, the hierarchical bounding box reader 800 may then fetch the corresponding packet from memory 6 and test all of the primitive bounding boxes 141, 142, 143 stored in the packet to identify and output primitives with primitive bounding boxes that overlap the current rendering tile.

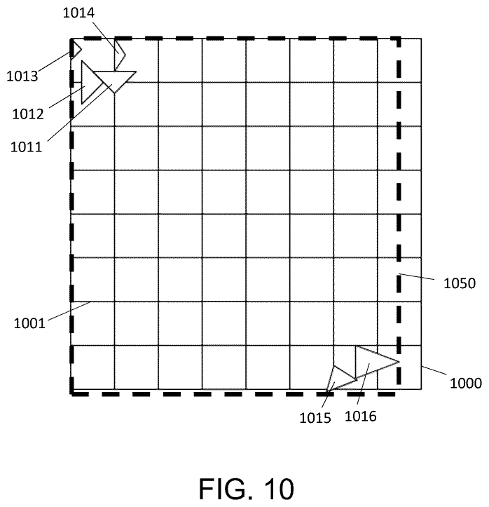

FIG. 10 illustrates another example set of primitives 1011-1016 that have been assigned to the same packet by tiler frontend 310 for a render output 1000 that is divided into 8×8 rendering tiles. Again, it will be appreciated that FIG. 10 is simplified for illustrative purposes, and in practice there may be many more primitives and bounding boxes defined for a render output, other numbers of rendering tiles, etc.

In this example, as shown in FIG. 10, a packet bounding box 1050 that bounds all of the primitives 1011-1016 in the packet overlaps all of the 8×8 rendering tiles of the render output 1000. Accordingly, in this example, the hierarchical bounding box reader 800 would find that the packet bounding box 1050 overlaps every rendering tile of the render output 1000, and so would fetch and process the corresponding packet for every rendering tile.

In this example, when the hierarchical bounding box reader 800 tests the primitive bounding boxes stored in the packet, it would find that, for the majority of the rendering tiles, none of the primitive bounding boxes overlap the rendering tile. For example, the hierarchical bounding box reader 800 would find by processing the packet data that none of the primitive bounding boxes for primitives 1011-1016 overlap rendering tile 1001, and thus none of primitives 1011-1016 need to be output and processed to generate rendering tile 1001.

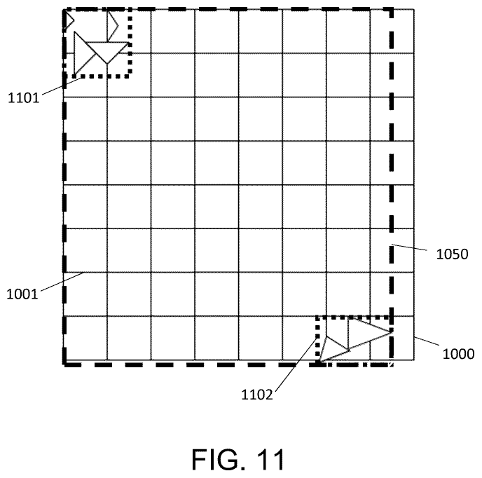

FIG. 11 illustrates an improved bounding box hierarchy arrangement. Again, it will be appreciated that FIG. 11 is simplified for illustrative purposes, and in practice there may be many more primitives and bounding boxes defined for a render output, etc., In this embodiment, as in the arrangement above, a lowest-level hierarchy level comprises primitive bounding boxes (not shown) that are each drawn (in screen space) around a respective primitive, and stored in primitive attribute information 416 of respective packets 410 in memory 6.

In contrast with the arrangement above (in which the next hierarchy level comprises packet bounding boxes that are each drawn around all of the primitives in a respective packet), in this embodiment the next hierarchy level comprises “primitive group bounding boxes” that are each drawn (in screen space) around a respective subset of (e.g. some but not all of) the primitives within a packet. For example, FIG. 11 illustrates a first primitive group bounding box 1101 that is drawn (in screen space) around a first group of primitives in the packet, and a second primitive group bounding box 1102 that is drawn (in screen space) around a second group of primitives in the packet. In the present embodiment, these primitive group bounding boxes are stored in the packet header 411 of respective packets 410 in memory 6. Alternatively, the primitive group bounding boxes may be stored in a dedicated region of a packet 410. The number of primitives in each group may also be stored.

In this embodiment, the next hierarchy level then comprises packet bounding boxes that are each drawn (in screen space) around all of the primitives in a respective packet, and stored in packet array 400 in memory 6. For example, FIG. 11 illustrates a packet bounding box 1050 that is drawn around all of the primitives in the packet. The next hierarchy level may then comprise packet group bounding boxes (not shown) that are each drawn (in screen space) around a respective group of packet bounding boxes, and stored in higher-level array 510 in memory 6. The next hierarchy level may then comprise higher-level bounding boxes (not shown) that are each drawn (in screen space) around a respective group of packet group bounding boxes, and stored in still higher-level array 520, and so on.

Thus, in embodiments of the technology described herein, an additional bounding box hierarchy level is provided in between the primitive bounding box level and the packet bounding box level.

In the present embodiment, each bounding box in the hierarchy is an axis-aligned minimum bounding box, but other arrangements would be possible. For example, less precise bounding boxes, such as bounding boxes at the resolution of individual rendering tiles, may be used.

In this embodiment, as in the arrangement described above, the hierarchical bounding box reader 800 may proceed by testing packet bounding box 1050 to determine whether a current rendering tile overlaps packet bounding box 1050. In this embodiment, the hierarchical bounding box reader 800 would again find that every rendering tile overlaps packet bounding box 1050, and so packet fetcher 840 fetches the packet data into cache 830 for further processing when processing every rendering tile.

In this embodiment, in contrast with the arrangement described above, when the hierarchical bounding box reader 800 receives a packet 410 for further processing, packet iterator 850 first tests the primitive group bounding boxes stored in the packet header 411 to identify any primitive group bounding boxes that overlap the current rendering tile being processed. Then, for each primitive group bounding box that the current rendering tile is found to overlap, packet iterator 850 tests the primitive bounding boxes that the respective primitive group bounding box is drawn around to identify primitives whose primitive bounding box overlaps the current tile being processed.

If a primitive group bounding box is found not to overlap the current rendering tile, the packet iterator 850 does not test the primitive bounding boxes that the primitive group bounding box is drawn around. Thus, packet iterator 850 only tests those primitive bounding boxes for which the corresponding primitive group bounding box is found to overlap the current rendering tile.

For example, when processing rendering tile 1001, packet iterator 850 first tests group bounding boxes 1101, 1102 to determine whether they overlap rendering tile 1001. In this case, packet iterator 850 would find that neither of primitive group bounding boxes 1101, 1102 overlaps rendering tile 1001, and so packet iterator 850 would not then test any of the primitive bounding boxes for the packet for rendering tile 1001. This means that an overall number of bounding box tests performed by packet iterator 850 can be reduced, e.g. as compared the arrangement described above. The inventors have found that this can improve rendering performance.

Primitive group bounding boxes for a packet could be generated after the groups for the packet have been determined, e.g. by processing each primitive in a packet to assign the primitives to groups, and then when the groups are determined, processing the primitives in each group to generate a primitive group bounding box for each group. The inventors have recognised, however, that this may effectively involve touching each primitive in a packet twice: once when generating the groups, and once when generating the primitive group bounding boxes.

Accordingly, in embodiments of the technology described herein, primitive groups and primitive group bounding boxes are generated together “on-the-fly”, such that each primitive in a packet may be touched only once.

One way of doing this would be to process each primitive in a packet in the order in which the primitives appear in the packet (corresponding to the order in which the primitives were defined for processing), and for each primitive, assign the primitive to a current group being generated until the current group becomes full, and then start a new group when the current group becomes full, and so on. Then, each time a primitive is assigned to a group, the primitive bounding box for the primitive may be used to expand the primitive group bounding box for the assigned primitive group.

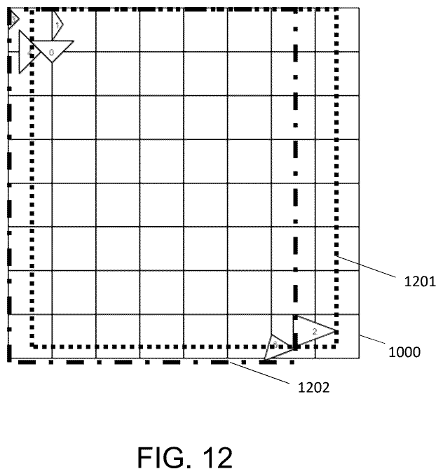

However, the inventors have found that assigning primitives to groups in order in this manner may not be optimal in all situations. For example, FIG. 12 illustrates a situation in which a first primitive group bounding box 1201 is drawn (in screen space) around the first to third primitives appearing in a packet, and a second primitive group bounding box 1202 is drawn (in screen space) around the fourth to sixth primitives appearing in the packet. As shown in FIG. 12, in this example, the primitive group bounding boxes 1201, 1202 generated based on primitive order may overlap many of the rendering tiles of the render output 1000.

In embodiments of the technology described herein, in order to generate better localised (smaller) primitive group bounding boxes, primitives are assigned to groups based on their screen space position. In order to facilitate this, multiple primitive groups may be “under construction” at any one time, and each time a primitive is added to a group under construction, the primitive group bounding box for the group under construction is expanded (if necessary) to encompass the primitive added to the group. When a primitive is to be added to a group, the primitive bounding box for the primitive is compared against the primitive group bounding box for any (each) group currently under construction, and the group to add the primitive to is selected based on the comparison.

In the present embodiment, each primitive in a packet (that has survived culling) is processed in the order in which the primitives appear in the packet (corresponding to the order in which the primitives were defined for processing), and added to a primitive group. Each primitive group has a maximum permitted number of 16 primitives, but other maximum numbers would be possible. In the present embodiment, up to 4 primitive groups can be under construction at any one time. Other maximum numbers of primitive groups under construction would be possible, such as 2, 8, or another number.

When a new packet is received for grouping, initially there are no primitive groups currently under construction. When there are no primitive groups currently under construction, the processing of a primitive triggers the start of construction of a new primitive group, and the primitive is added to the newly started primitive group. When a primitive is added to a newly started primitive group, the group bounding box for the newly started primitive group is set equal to the primitive bounding box for the primitive.

When there is (exactly) one primitive group currently under construction, a next primitive to be processed may be added to the existing primitive group currently under construction, or construction of a new primitive group may be started and the primitive added to the newly started primitive group. In the present embodiment, a primitive is added to the existing primitive group currently under construction if the primitive bounding box for the primitive overlaps (partially or fully) the group bounding box for the existing primitive group currently under construction. When a primitive is added to an existing primitive group currently under construction, the primitive bounding box for the primitive is used to expand (as necessary) the group bounding box for the existing primitive group. Otherwise, if the primitive bounding box for the primitive does not overlap the group bounding box for the existing primitive group currently under construction, construction of a new primitive group is started and the primitive is added to the newly started primitive group.

When there are two or more primitive groups currently under construction, it is possible that a primitive bounding box for a primitive may overlap group bounding boxes for two or more primitive groups currently under construction, such that adding the primitive to one of the two or more primitive groups would result in overlapping group bounding boxes. The inventors have recognised, however, that this possibility of there being two overlapping groups under construction at the same time should be avoided in order to maintain correct primitive ordering.

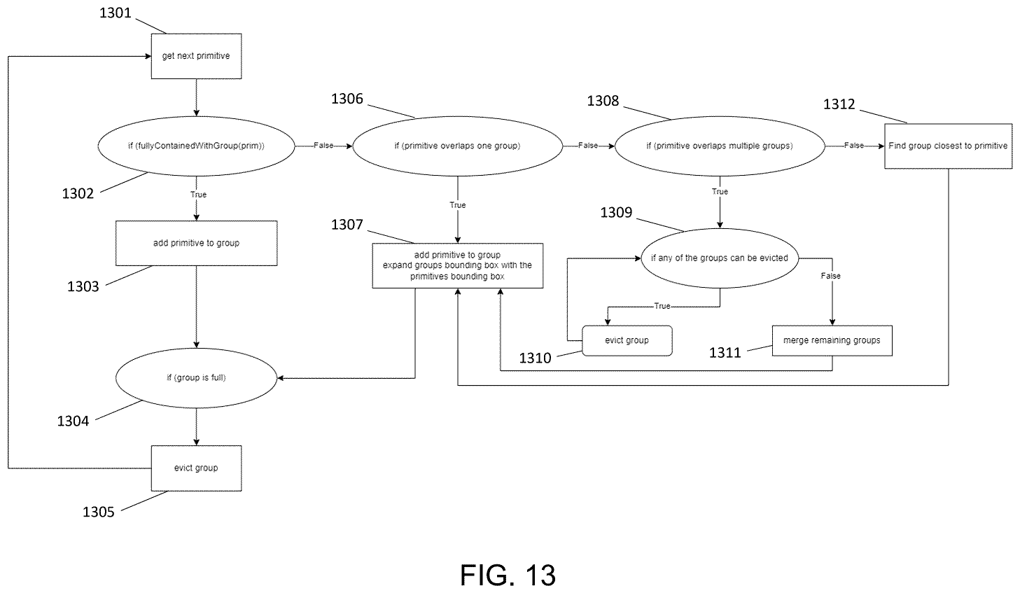

FIG. 13 shows in more detail a process for grouping primitives in a packet into primitive groups, and generating primitive group bounding boxes, in accordance with embodiments of the technology described herein. In this process, primitive groups and primitive group bounding boxes may be generated together “on-the-fly”, such that each primitive in a packet may be touched only once. Furthermore, the process of FIG. 13 is such that the possibility of there being two overlapping groups under construction at the same time is avoided. The process of FIG. 13 may be performed by bounding box generation stage 323 on a (each) packet after the bounding box generation stage 323 has culled any primitives from the packet, and generated primitive bounding boxes for surviving primitives in the packet.

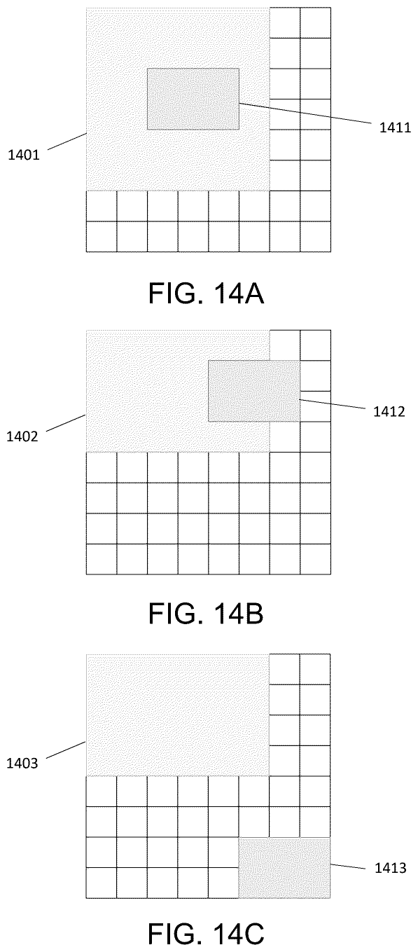

As shown in FIG. 13, for each primitive in a packet (step 1301), it may be determined (at step 1302) whether the primitive bounding box for the primitive is fully contained within (i.e. fully overlaps) the current primitive group bounding box for only one primitive group that is currently under construction. For example, FIG. 14A illustrates a primitive bounding box 1411 that is fully contained within (i.e. fully overlaps) a primitive group bounding box 1401.

If the primitive bounding box for the primitive is fully contained within the current primitive group bounding box for only one primitive group that is currently under construction, the primitive is added to that primitive group (at step 1303), and it is then determined (at step 1304) whether that primitive group is now full (e.g. includes the maximum permitted number of 16 primitives).

If the primitive group to which the primitive was added is now full (e.g. includes the maximum permitted number of 16 primitives), construction of that primitive group is complete and it is evicted from processing (step 1305). This may involve the primitive group bounding box for the completed primitive group being written to the packet header 411. The process may then move on to the next primitive in the packet (step 1301).

If (at step 1302) the primitive bounding box for the primitive is not fully contained within the current primitive group bounding box for only one primitive group that is currently under construction, it may be determined (at step 1306) whether the primitive bounding box for the primitive partially overlaps the current primitive group bounding box for only one primitive group that is currently under construction. For example, FIG. 14B illustrates a primitive bounding box 1412 that partially overlaps a primitive group bounding box 1402.

If the primitive bounding box for the primitive partially overlaps the current primitive group bounding box for only one primitive group that is currently under construction, the primitive is added to that primitive group and the primitive bounding box for the primitive is used to expand the primitive group bounding box for that primitive group (at step 1307).

It is then determined (at step 1304) whether the primitive group to which the primitive was added is now full (e.g. includes the maximum permitted number of 16 primitives). If the primitive group to which the primitive was added is now full, construction of that primitive group is complete and it is evicted from processing (step 1305). The process may then move on to the next primitive in the packet (step 1301).

Thus, when a primitive bounding box for a primitive fully or partially overlaps exactly one primitive group bounding box for a primitive group that is currently under construction, the primitive is added to that primitive group.

If (at step 1306) the primitive bounding box for the primitive does not overlap the current primitive group bounding box for only one primitive group that is currently under construction, it may be determined (at step 1308) whether the primitive bounding box for the primitive overlaps the current primitive group bounding boxes for two or more primitive groups that are currently under construction.

As mentioned above, if the primitive bounding box for the primitive does overlap the current primitive group bounding boxes for two or more primitive groups that are currently under construction, the possibility of there being two or more groups under construction at the same time that have overlapping primitive group bounding boxes should be avoided. To do this, in the present embodiment, before the primitive is added to a group, the number of “overlapping primitive groups” that are currently under construction is reduced to less than two (i.e. to one or zero). To do this, in the present embodiment, one or more overlapping primitive groups currently under construction may be completed and evicted early (i.e. before reaching the maximum number of 16 primitives) and/or two or more overlapping primitive groups currently under construction may be merged into a single group.

As shown in FIG. 13, if (at step 1308) the primitive bounding box for the primitive overlaps the current primitive group bounding boxes for two or more primitive groups that are currently under construction, it may be determined (at step 1309) whether any of these overlapping primitive groups are eligible for “early eviction”, and any of the overlapping primitive groups that are eligible for early eviction are completed and evicted (at step 1310). In the present embodiment, each primitive group has a minimum permitted number of primitives, and it is determined that a primitive group is eligible for early eviction if the primitive group already includes (at least) the minimum permitted number of primitives. In the present embodiment, the minimum permitted number of primitives is less than or equal to half of the maximum permitted number of primitives, e.g. less than or equal to 8 primitives. Other numbers would be possible.

If, after evicting all overlapping primitive groups that are eligible for early eviction, two or more overlapping primitive groups remain (that were not eligible for early eviction, e.g. each contain fewer than 8 primitives), then a respective pair(s) of these primitive groups may be merged (at step 1311) into a respective single primitive group(s), and any merged primitive group that thereby becomes eligible for early eviction may be completed and evicted. Merging a pair of primitive groups may involve combining the primitives in both groups into one merged group, and combining the primitive group bounding boxes for both groups into a single primitive group bounding box for the merged group.

This merging and/or evicting may continue until there are no overlapping primitive groups currently under construction, or until only one overlapping primitive group remains (that is not eligible for early eviction, e.g. contains fewer than 8 primitives).

If there are no overlapping primitive groups currently under construction, construction of a new primitive group may be started and the primitive added to the new primitive group. Otherwise, if only one overlapping primitive group remains (that is not eligible for early eviction, e.g. contains fewer than 8 primitives), the primitive may be added to that primitive group (at step 1307).

If (at step 1308) the primitive bounding box for the primitive does not overlap the current primitive group bounding boxes for plural primitive groups that are currently under construction, then the primitive bounding box does not overlap a current primitive group bounding box for any primitive group that is currently under construction. For example, FIG. 14C illustrates a primitive bounding box 1413 that does not overlap a primitive group bounding box 1403.

In this case, if there are less than the maximum number of primitive groups currently under construction (e.g. less than 4 primitive groups currently under construction), construction of a new primitive group may be started, and the primitive added to the new primitive group. Otherwise, if the maximum number of primitive groups (e.g. 4) are currently under construction, any primitive group that is eligible for early eviction may be completed and evicted, construction of a new primitive group may be started, and the primitive added to the new primitive group.

Otherwise, if the maximum number of primitive groups (e.g. 4) are currently under construction, and none of those primitive groups are eligible for early eviction, a primitive group currently under construction having the closest primitive group bounding box to the primitive bounding box for the primitive may be determined (at step 1312), and the primitive may be added to the primitive group having the closest primitive group bounding (at step 1307). In this case, a distance between two non-intersecting bounding boxes may be defined as the number of additional tiles that would be covered by a bounding box that is the union of the two non-intersecting bounding boxes.

The inventors have found that this process can generate primitive groups and primitive group bounding boxes “on-the-fly” with primitive group bounding boxes that are better localised (i.e. smaller), e.g. as compared to the arrangement described above with reference to FIG. 12. This can reduce an overall number of bounding box tests performed by packet iterator 850, and thus improve rendering performance.

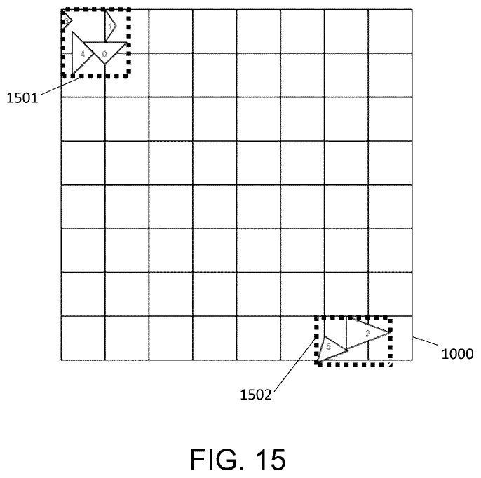

For example, FIG. 15 illustrates the same packet of primitives as FIG. 12, but with primitive group bounding boxes 1501, 1502 generated using a process in accordance with embodiments of the technology described herein. As shown in FIG. 15, in this embodiment, a first primitive group for the packet contains first, second, fourth and fifth primitives of the packet, and a second primitive group for the packet contains third and sixth primitives of the packet. Thus, the overall order of the primitives within the packet is not maintained in the resulting primitive groups. However, for any given rendering tile of the render output 1000, the processing order of primitives of the packet that overlap that rendering tile will be maintained.

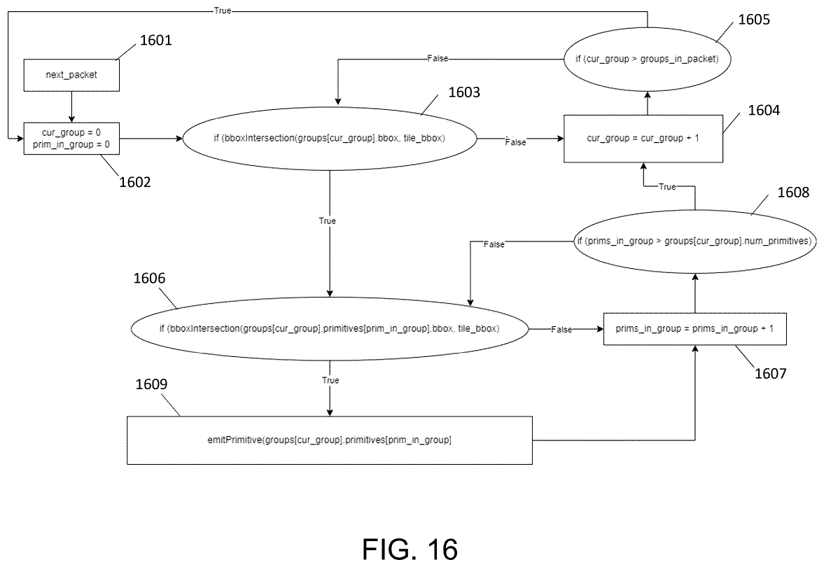

FIG. 16 shows a process for processing packets to identify and output primitives to be processed for a current rendering tile, in accordance with embodiments of the technology described herein. The process of FIG. 16 may be performed by packet iterator 850 of hierarchical bounding box reader 800 on each packet it receives for processing.

As shown in FIG. 16, when hierarchical bounding box reader 800 find that a current rendering tile overlaps a packet bounding box, packet fetcher 840 fetches the corresponding packet into cache 830 (step 1601), and the first primitive in the first primitive group is selected (step 1602). It is then determined whether the current rendering tile overlaps the primitive group bounding box for the first primitive group (at step 1603).

If the current rendering tile does not overlap the primitive group bounding box for the first primitive group, the process moves on to the next primitive group in the packet (if present) (steps 1604, 1605), and the primitive group bounding box for the next primitive group is tested (at step 1603). If the current packet has no more primitive group bounding boxes to test (at step 1605), the process may move on to the next packet.

If (at step 1603) the current rendering tile is found to overlap a primitive group bounding box for a primitive group, it is determined whether the current rendering tile overlaps the primitive bounding box for the first primitive in that primitive group (at step 1606).

If the current rendering tile does not overlap the primitive bounding box for the first primitive in the primitive group, the process moves on to the next primitive in the primitive group (if present) (steps 1607, 1608), and the primitive bounding box for the next primitive is tested (at step 1606). If the current primitive group has no more primitive bounding boxes to test (at step 1608), the process moves on to the next primitive group in the packet (if present) (steps 1604, 1605), and the primitive group bounding box for the next primitive group is tested (at step 1603). If the current packet has no more primitive group bounding boxes to test (at step 1605), the process may move on to the next packet.

If (at step 1606) the current rendering tile is found to overlap a primitive bounding box, the hierarchical bounding box reader 800 emits the primitive for rasterising and rendering (at step 1609).

The hierarchical bounding box reader 800 thereby iterates through primitive groups and primitives in a packet such that, for any given rendering tile, primitives will be emitted in the order in which they were originally specified.

Although the embodiments described above involve generating primitive group bounding boxes, it would be possible to generate bounding boxes at other levels of the hierarchy of bounding boxes in a corresponding manner.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

1. A method of operating a tile-based graphics processor that is operable to generate a render output by building a hierarchy of bounding boxes to be used to identify primitives to process to generate a rendering tile of the render output; the method comprising building at least one level of a hierarchy of bounding boxes by:
constructing one or more groups of primitives by adding primitives to the one or more groups; and
generating, for each group, a group bounding box that bounds the primitives added to the respective group;
wherein a primitive is added to a group by:
comparing a position of the primitive with a position of any group currently under construction;
selecting a group to add the primitive to based on the comparison; and
adding the primitive to the selected group.

2. The method of claim 1, wherein comparing a position of the primitive with a position of a group currently under construction comprises: comparing a primitive bounding box that bounds the primitive with a group bounding box that bounds any primitives already added to the group currently under construction.

3. The method of claim 2, comprising determining whether the primitive bounding box overlaps a group bounding box for only one group currently under construction; and
when it is determined that the primitive bounding box overlaps a group bounding box for only one group currently under construction:
adding the primitive to the only one group.

4. The method of claim 2, comprising determining whether the primitive bounding box overlaps group bounding boxes for two or more groups currently under construction; and
when it is determined that the primitive bounding box overlaps group bounding boxes for two or more groups currently under construction:
reducing the number of groups currently under construction for which a group bounding box is overlapped by the primitive bounding box to less than two; and
thereafter adding the primitive to a group.

5. The method of claim 4, comprising reducing the number of groups currently under construction by:
merging at least two groups under construction into a single merged group; and/or
completing at least one group under construction.

6. The method of claim 5, comprising:
determining whether a group includes greater than or equal to a minimum number of primitives; and
when it is determined that the group includes greater than or equal to the minimum number of primitives:
completing the group.

7. The method of claim 5, comprising:
determining whether two groups under construction each include less than a minimum number of primitives; and
when it is determined that two groups under construction each include less than the minimum number of primitives:
merging the two groups under construction into a single merged group.

8. The method of claim 7, wherein the minimum number of primitives is less than or equal to half of a maximum number of primitives that a group can contain.

9. The method of claim 2, comprising determining whether the primitive bounding box does not overlap a group bounding box for any of a maximum number of groups that are currently under construction; and
when it is determined that the primitive bounding box does not overlap a group bounding box for any of a maximum number of groups that are currently under construction:
determining a group currently under construction for which a group bounding box is closest to the primitive bounding box; and
adding the primitive to the determined group.

10. The method of claim 1, comprising:
traversing the hierarchy of bounding boxes to identify primitives to process to generate a rendering tile; and
processing the identified primitives to generate the rendering tile.

11. A non-transitory computer readable storage medium storing software code which when executing on a processor performs the method of claim 1.

12. A tile-based graphics processor that is operable to generate a render output by building a hierarchy of bounding boxes to be used to identify primitives to process to generate a rendering tile of the render output; the processor comprising:
a bounding box hierarchy building circuit configured to build at least one level of a hierarchy of bounding boxes by:
constructing one or more groups of primitives by adding primitives to the one or more groups; and
generating, for each group, a group bounding box that bounds the primitives added to the respective group; and
a processing circuit configured to add a primitive to a group by:
comparing a position of the primitive with a position of any group currently under construction;
selecting a group to add the primitive to based on the comparison; and
adding the primitive to the selected group.

13. The processor of claim 12, wherein the processing circuit is configured to compare a position of a primitive with a position of a group currently under construction by: comparing a primitive bounding box that bounds the primitive with a group bounding box that bounds any primitives already added to the group currently under construction.

14. The processor of claim 13, wherein the processing circuit is configured to:
determine whether a primitive bounding box for a primitive overlaps a group bounding box for only one group currently under construction; and
when it is determined that the primitive bounding box overlaps a group bounding box for only one group currently under construction:
add the primitive to the only one group.

15. The processor of claim 13, wherein the processing circuit is configured to:
determine whether a primitive bounding box for a primitive overlaps group bounding boxes for two or more groups currently under construction; and
when it is determined that the primitive bounding box overlaps group bounding boxes for two or more groups currently under construction:
reduce the number of groups currently under construction for which a group bounding box is overlapped by the primitive bounding box to less than two; and
thereafter add the primitive to a group.

16. The processor of claim 15, wherein the processing circuit is configured to reduce the number of groups currently under construction by:
merging at least two groups under construction into a single merged group;
and/or completing at least one group under construction.

17. The processor of claim 16, wherein the processing circuit is configured to:
determine whether a group includes greater than or equal to a minimum number of primitives; and
when it is determined that the group includes greater than or equal to the minimum number of primitives:
complete the group.

18. The processor of claim 16, wherein the processing circuit is configured to:
determine whether two groups under construction each include less than a minimum number of primitives; and
when it is determined that two groups under construction each include less than the minimum number of primitives:
merge the two groups under construction into a single merged group.

19. The processor of claim 13, wherein the processing circuit is configured to:
determine whether a primitive bounding box for a primitive does not overlap a group bounding box for any of a maximum number of groups that are currently under construction; and
when it is determined that the primitive bounding box does not overlap a group bounding box for any of a maximum number of groups that are currently under construction:
determine a group currently under construction for which a group bounding box is closest to the primitive bounding box; and
add the primitive to the determined group.

20. The processor of claim 12, further comprising a bounding box hierarchy traversal circuit configured to:
traverse a hierarchy of bounding boxes built by the bounding box hierarchy building circuit to identify primitives to process to generate a rendering tile; and
process the identified primitives to generate the rendering tile.
